(19) United States
(12) Patent Application Publication
(10) Pub. No.: US 2026/0175252 A1
(43) Pub. Date: Jun. 25, 2026

(54) METHOD FOR GENERATING FILM ROLL SHEETS, COATING METHOD AND SYSTEM, DEVICE, MEDIUM, AND PRODUCT

(71) Applicant: Contemporary Amperex Technology Co., Limited, Ningde (CN)

(72) Inventors: Bingyang ZHAN, Ningde (CN); Jingdong ZHANG, Ningde (CN); Weigang CHEN, Ningde (CN); Zhihui ZHEN, Ningde (CN); Qiangjun WANG, Ningde (CN); Liangjie YAN, Ningde (CN); Anxiang QIN, Ningde (CN); Liangcan XIA, Ningde (CN)

(73) Assignee: Contemporary Amperex Technology Co., Limited, Ningde (CN)

(21) Appl. No.: 19/543,906

(22) Filed: Feb. 19, 2026

Related U.S. Application Data
(63) Continuation of application No. PCT/CN2024/090385, filed on Apr. 28, 2024.

(30) Foreign Application Priority Data
Aug. 22, 2023 (CN) 202311061124.6
Aug. 22, 2023 (CN) 202311061651.7
Aug. 22, 2023 (CN) 202311061686.0

(51) Int. Cl. B05C 11/10; B05C 5/02; B65H 19/10

(52) U.S. Cl. CPC B05C 11/1015; B05C 5/0245; B65H 19/10

(57) ABSTRACT

A method includes: acquiring a parameter processing mode of film roll parameters, wherein the parameter processing mode is used to indicate a parameter acquisition manner of the film roll parameters in the current operating state of a coating machine; acquiring the parameter content of the film roll parameters according to the parameter acquisition manner indicated by the parameter processing mode; and generating a new film roll sheet based on the parameter content, wherein the new film roll sheet is used to record coating process parameters of a substrate.

### CROSS-REFERENCE TO RELATED APPLICATIONS

The present application is a continuation of International Patent Application No. PCT/CN2024/090385, filed on Apr. 28, 2024, which claims priority to Chinese patent application No. 202311061651.7, filed on Aug. 22, 2023 and entitled “METHOD FOR GENERATING FILM ROLL SHEETS, APPARATUS, DEVICE, MEDIUM, AND PRODUCT”, each are incorporated herein by reference in their entirety.

The present application also claims priority to Chinese patent application No. 202311061124.6, filed on Aug. 22, 2023 and entitled “COATING SYSTEM AND COATING METHOD”, which is incorporated herein by reference in its entirety.

The present application also claims priority to Chinese patent application No. 202311061686.0, filed on Aug. 22, 2023 and entitled “COATING SYSTEM AND COATING METHOD”, which is incorporated herein by reference in its entirety.

### TECHNICAL FIELD

The present application relates to the technical field of battery coating, and in particular, to a method for generating film roll sheets, a coating method and system, a device, a medium, and a product.

### BACKGROUND

A coating process is an important process in battery production. A battery coating process refers to uniformly coating the prepared slurry onto the surface of a metal foil, and then drying the surface to respectively prepare positive and negative electrode plates.

In the battery coating process, film roll data is usually created manually for film rolls. The manner for creating film roll data manually is relatively limited, has relatively low creation efficiency of film roll data, and has the risk of manually inputting incorrect information. Therefore, the manner for creating film roll data cannot meet coating process scenes with relatively high real-time requirements and accuracy requirements.

The above statements are only used to provide background information related to the present application and do not necessarily constitute the prior art.

### SUMMARY OF THE DISCLOSURE

Embodiments of the present application at least provide a method for generating film roll sheets, a coating method and system, a device, a medium, and a product, which can alleviate the problem that the manner for creating film roll data manually cannot meet coating process scenes with relatively high real-time requirements and accuracy requirements.

According to a first aspect, an embodiment of the present application provides a method for generating film roll sheets, including:
acquiring a parameter processing mode of film roll parameters, wherein the parameter processing mode is used to indicate a parameter acquisition manner of the film roll parameters in the current operating state of a coating machine;
acquiring the parameter content of the film roll parameters according to the parameter acquisition manner indicated by the parameter processing mode; and generating a new film roll sheet based on the parameter content, wherein the new film roll sheet is used to record coating process parameters of a substrate.

The above processing mode can select the parameter acquisition manner of the film roll parameters according to the current operating state of the coating machine, thereby selecting the parameter acquisition manner that is more compatible with the current operating state of the coating machine to meet different operating states of the coating machine. A manner for acquiring the parameter processing mode through a mode selection page can also enrich the parameter acquisition manner of the film roll parameters, so as to meet coating process scenes with relatively high real-time requirements and accuracy requirements.

In some embodiments, the acquiring the parameter content of the film roll parameters according to the parameter acquisition manner indicated by the parameter processing mode includes:
displaying a first page corresponding to the parameter processing mode based on a detected film roll sheet creation request, wherein the parameter acquisition manner indicated by the parameter processing mode includes acquisition through the first page; and
acquiring the parameter content of the film roll parameters through the first page.

In the above embodiment, by displaying the first page corresponding to the parameter processing mode and acquiring the parameter content through the first page, the flexibility of acquiring the film roll parameters can be improved, thereby meeting various operating states of the coating machine.

In some embodiments, the acquiring the parameter content of the film roll parameters through the first page includes:
displaying a parameter editing area of the film roll parameters through the first page; and
detecting the edited content in the parameter editing area, and determining the parameter content of the film roll parameter according to the edited content.

In the above embodiment, the manner for acquiring the parameter content of the film roll parameters through the parameter editing area can more flexibly acquire the parameter content, so as to meet various operating states of the coating machine.

In some embodiments, the generating a new film roll sheet based on the parameter content includes:
performing validity check on the parameter content in the case of detecting a parameter check event to obtain a check result; and
generating the new film roll sheet based on the parameter content in the case of determining that the check result is successful.

In the above embodiment, by performing validity check on the parameter content, errors in film roll numbers caused by human error operations can be reduced, thereby improving the accuracy of the film roll numbers.

In some embodiments, the performing validity check on the parameter content in the case of detecting a parameter check event to obtain a check result includes:
performing check on the content length of the parameter content to obtain a first sub-check result;
performing check on various components of the parameter content to obtain a second sub-check result; and
obtaining the check result based on the first sub-check result and the second sub-check result.

In the above embodiment, errors in film roll numbers caused by human error operations can be reduced, thereby improving the accuracy of the film roll numbers.

In some embodiments, the method further includes:
controlling a check display identifier in the first page to be switched from a first display state to a second display state in the case of determining that the check result is successful, wherein the second display state is used to indicate that the check result is successful.

In the above embodiment, the check result of the parameter content can be displayed to users more intuitively, thereby improving the generation efficiency and coating efficiency of film roll sheets.

In some embodiments, the acquiring the parameter content of the film roll parameters through the first page includes:
displaying a parameter display area of the film roll parameters and an acquisition identifier of the film roll parameters through the first page;
sending an acquisition request to a film roll management system in the case of detecting a trigger event for the acquisition identifier; and
acquiring the parameter content returned by the film roll management system based on the acquisition request, and displaying the parameter content in the parameter display area.

In the above embodiment, the film roll numbers can be automatically acquired, thereby improving the degree of automation of the entire process, improving the accuracy of the film roll numbers, and also saving the labor cost.

In some embodiments, the generating a new film roll sheet based on the parameter content includes:
detecting a roll change signal of the coating machine according to a preset time interval in the case of determining that a target detection identifier indicates that the detection is enabled, wherein the target detection identifier is used to indicate whether to perform detection of the roll change signal; and
generating the new film roll sheet based on the parameter content in the case of detecting the roll change signal.

Through the above processing mode, a new film roll sheet can be automatically generated based on the parameter content, so that when a roll change apparatus performs a roll change operation, a new film roll sheet can be quickly generated, so as to record new coating process information.

In some embodiments, the acquiring the parameter content of the film roll parameters according to the parameter acquisition manner indicated by the parameter processing mode includes:
acquiring the parameter content of the film roll parameters from a target management system in the case of detecting the roll change signal of the coating machine.

Through the above processing mode, the process of acquiring film roll parameters can be automatically completed, and the process of creating film roll sheets can be automatically completed, thereby improving the degree of automation of the entire process, saving the labor cost, and reducing errors caused by manual operation.

In some embodiments, the method further includes:
determining and displaying a second page based on a detected parameter viewing request, and displaying the parameter display area of the film roll parameters in the second page.

Through the above processing mode, the acquired parameter content can be displayed, and setting the film roll parameters to be non-editable can reduce errors caused by manual operation.

In some embodiments, the method further includes:
stopping entering coating process parameters into the current film roll sheet in the case of detecting that the current film roll sheet is completed, storing the current film roll sheet into a target storage space, and performing an operation of generating a new film roll sheet based on the parameter content.

Through the above processing mode, the entering accuracy of coating process parameters can be improved, and the consistency and traceability of a new film roll sheet and a film roll stock can be improved.

In some embodiments, the method further includes:
displaying a third page based on a detected input request of film roll sheet attributes, wherein the third page contains an attribute editing area; and
determining film roll sheet attributes of the new film roll sheet based on the edited content in the attribute editing area.

Through the above processing mode, due to coating characteristics of a single-sided coating machine, by means of setting film roll sheet attributes, coating process parameters of each coating surface can be accurately recorded.

In some embodiments, the method further includes:
acquiring a target film roll sheet of the coated surface in the case of determining that a substrate to be coated contains a coated surface based on the film roll sheet attributes; and
establishing an association relationship between the target film roll sheet and the new film roll sheet.

Through the above processing mode, film roll sheets generated during the coating process on each coating surface of the substrate can be associated, thereby achieving the association of production process information, and ensuring quick and accurate traceability of film rolls during battery production.

According to a second aspect, the present application provides an apparatus for generating film roll sheets, including:
a first acquisition unit, configured to acquire a parameter processing mode of film roll parameters, wherein the parameter processing mode is used to indicate a parameter acquisition manner of the film roll parameters in the current operating state of a coating machine;
a second acquisition unit, configured to acquire the parameter content of the film roll parameters according to the parameter acquisition manner indicated by the parameter processing mode; and
a generation unit, configured to generate a new film roll sheet based on the parameter content, wherein the new film roll sheet is used to record coating process parameters of a substrate.

According to a third aspect, some embodiments of the present application provide a coating system, including: an unwinding apparatus, a driving apparatus, a collection device, a winding apparatus, and a control apparatus.

The driving apparatus is configured to drive a substrate unwound by the unwinding apparatus to move towards the winding apparatus, and the winding apparatus is configured to wind the substrate.

The collection device is configured to collect substrate parameters of the substrate passing through the collection device.

The control apparatus is configured to predict the winding time when the substrate is wound by the winding apparatus based on coating process parameters, and store the substrate parameters acquired from the collection device into the film roll sheet corresponding to the substrate at the winding time, wherein the film roll sheet is generated by the method for generating film roll sheets according to the first aspect above.

In the solution provided in this embodiment, since the substrate parameters of the substrate are stored based on the winding time of the substrate, the situation of discrepancies between the film roll sheet and the film roll caused by storing the substrate parameters of the substrate before the substrate is wound by the coating and winding apparatus can be greatly reduced.

In some embodiments, the control apparatus includes: a host computer and a slave computer.

The slave computer is configured to acquire driving parameters of the driving apparatus and transmit the driving parameters to the host computer.

The host computer is configured to acquire the substrate parameters from the collection device, predict the winding time when the substrate is wound by the winding apparatus based on the driving parameters and pre-configured distance parameters, and store the substrate parameters into the film roll sheet corresponding to the substrate at the winding time. The distance parameters are used to indicate the transmission distance between the collection device and the winding apparatus.

In the solution provided in this embodiment, the control apparatus in the coating system is jointly implemented by the host computer and the slave computer, and the host computer and the slave computer respectively interact with different devices in the coating system, which helps to improve the reliability of the control apparatus.

In some embodiments, the host computer is configured to:
predict the transmission duration required for the substrate to be transmitted from the collection device to the winding apparatus based on the driving parameters and the distance parameters; and
calculate the winding time based on the transmission duration and the collection time of the substrate parameters collected by the collection device.

In the solution provided in this embodiment, the transmission duration from the collection device to the winding apparatus is calculated, and then the winding time is calculated, which can improve the accuracy of the determined winding time.

In some embodiments, the host computer is configured to:
calculate the target distance of the substrate being transmitted in each rotational speed collection cycle based on rotational speed collection cycles contained in the driving parameters and the rotational speed collected in each rotational speed collection cycle;
calculate the cumulative number of collections based on the target distance and the distance parameters; and
calculate the product of the cumulative number of collections and the rotational speed collection cycle to obtain the transmission duration.

In the solution provided in this embodiment, the cumulative collection cycle is calculated according to multiple rotational speed collection cycles and the rotational speed in each collection cycle, and then the transmission duration is calculated. This calculation mode considers the situation where the rotational speed of the driving apparatus is not constant in actual operating conditions. Therefore, this calculation mode is closer to the actual operating conditions of the driving apparatus, thereby improving the accuracy of the finally calculated transmission duration.

In some embodiments, the coating system further includes:
a cutter apparatus, configured to cut off the substrate passing through the cutter apparatus when it is determined that a roll change condition is met currently; and
the control apparatus, further configured to control the winding apparatus to be switched to a new roll drum and create a film roll sheet corresponding to the new roll drum.

In the solution provided in this embodiment, the cutter apparatus is used in the coating system to cut off the substrate, which can improve the coating efficiency compared to a manner of manually cutting off the substrate. Furthermore, the control apparatus controls the winding apparatus to be automatically switched to a new roll drum, and creates a film roll sheet corresponding to the new roll drum, thereby sequentially achieving automatic roll change of the winding apparatus, and improving the coating efficiency.

In some embodiments, the coating system further includes a coating device, and the coating device includes a coating die head and a coating oven.

The coating die head is configured to coat the substrate passing through the coating die head.

The coating oven is configured to bake the substrate coated by the coating die head.

In the solution provided in this embodiment, the coating system includes the coating die head for coating the substrate and the coating oven for baking the coated substrate. The introduction of coating devices such as the coating die head and the coating oven allows the collection device to collect more substrate parameters, which helps to understand the coating performance of the coating system.

According to a fourth aspect, some embodiments of the present application provide a coating method applied to the coating system according to the third aspect above. The coating method includes:
allowing the control apparatus to predict the winding time when the substrate is wound by the winding apparatus based on coating process parameters; and
allowing the control apparatus to store the substrate parameters of the substrate collected by the collection device into the film roll sheet corresponding to the substrate at the winding time.

In the solution provided in this embodiment, since the substrate parameters of the substrate are stored based on the winding time of the substrate, the situation of discrepancies between the film roll sheet and the film roll caused by storing the substrate parameters of the substrate before the substrate is wound by the coating and winding apparatus can be greatly reduced.

In some embodiments, the control apparatus includes a host computer and a slave computer. The allowing the control apparatus to predict the winding time when the substrate is wound by the winding apparatus based on coating process parameters includes:
allowing the slave computer to acquire driving parameters of the driving apparatus and transmit the driving parameters to the host computer; and
allowing the host computer to acquire the substrate parameters collected by the collection device, predict the winding time when the substrate is wound by the winding apparatus based on the driving parameters and pre-configured distance parameters, and store the substrate parameters into the film roll sheet corresponding to the substrate at the winding time. The distance parameters are used to indicate the transmission distance between the collection device and the winding apparatus.

In the solution provided in this embodiment, the host computer and the slave computer respectively interact with different devices in the coating system to determine the winding time when the substrate is wound by the winding apparatus, which helps to improve the reliability of the control apparatus.

In some embodiments, the allowing the host computer to acquire the substrate parameters collected by the collection device and predict the winding time when the substrate is wound by the winding apparatus based on the driving parameters and pre-configured distance parameters includes:
allowing the host computer to predict the transmission duration required for the substrate to be transmitted from the collection device to the winding apparatus based on the driving parameters and the distance parameters; and
allowing the host computer to calculate the winding time based on the transmission duration and the collection time of the substrate parameters collected by the collection device.

In the solution provided in this embodiment, the transmission duration from the collection device to the winding apparatus is calculated, and then the winding time is calculated, which can improve the accuracy of the determined winding time.

In some embodiments, the allowing the host computer to predict the transmission duration required for the substrate to be transmitted from the collection device to the winding apparatus based on the driving parameters and the distance parameters includes:
calculating the target distance of the substrate being transmitted in each rotational speed collection cycle based on rotational speed collection cycles contained in the driving parameters and the rotational speed collected in each rotational speed collection cycle;
calculating the cumulative number of collections based on the target distance and the distance parameters; and
calculating the product of the cumulative number of collections and the rotational speed collection cycle to obtain the transmission duration.

In the solution provided in this embodiment, the cumulative collection cycle is calculated according to multiple rotational speed collection cycles and the rotational speed in each collection cycle, and then the transmission duration is calculated. This calculation mode considers the situation where the rotational speed of the driving apparatus is not constant in actual operating conditions. Therefore, this calculation mode is closer to the actual operating conditions of the driving apparatus, thereby improving the accuracy of the finally calculated transmission duration.

According to a fifth aspect, some embodiments of the present application provide a coating method applied to the coating system according to the third aspect above. The coating method includes:
predicting the winding time when the substrate is wound by the winding apparatus based on coating process parameters; and
storing the substrate parameters of the substrate acquired from the collection device into the film roll sheet corresponding to the substrate at the winding time.

In some embodiments, the predicting the winding time when the substrate is wound by the winding apparatus based on coating process parameters includes:
predicting the transmission duration required for the substrate to be transmitted from the collection device to the winding apparatus based on the driving parameters acquired from the driving apparatus and pre-configured distance parameters, the distance parameters being used to indicate the distance between the collection device and the winding apparatus; and
calculating the winding time based on the transmission duration and the collection time of the substrate parameters acquired from the collection device.

In some embodiments, the predicting the transmission duration required for the substrate to be transmitted from the collection device to the winding apparatus based on the driving parameters acquired from the driving apparatus and pre-configured distance parameters includes:
calculating the target distance of the substrate being transmitted in each rotational speed collection cycle based on rotational speed collection cycles contained in the driving parameters and the rotational speed collected in each rotational speed collection cycle;
calculating the cumulative number of collections based on the target distance and the distance parameters; and
calculating the product of the cumulative number of collections and the rotational speed collection cycle to obtain the transmission duration.

According to a sixth aspect, an embodiment of the present application provides a coating system, including: a statistical process control system, a manufacturing execution system, and a controller.

The controller is configured to generate a roll change signal in the case of detecting that a winding apparatus of a coating machine performs a disconnecting operation and is connected to a target film roll.

The statistical process control system is configured to send a processing request for film roll numbers to the manufacturing execution system in response to the roll change signal, acquire a first film roll number of a target film roll sent by the manufacturing execution system based on the processing request, and create a first film roll sheet based on the first film roll number, wherein the first film roll sheet is used to record the production process information of the target film roll during the coating process; and the first film roll sheet is generated by the method for generating film roll sheets according to the first aspect above.

The manufacturing execution system is configured to determine the first film roll number of the target film roll in response to the processing request, and send the first film roll number to the statistical process control system.

In some embodiments, the coating system further includes: a first register.

The first register is configured to store the roll change signal, wherein the storage address of the first register is a first storage address.

The statistical process control system is configured to read first storage data in the first register, and determine that the roll change signal is detected in the case of determining that the first storage data is first data, wherein the first data is used to represent that the winding apparatus of the coating machine is connected to the target film roll.

In the above embodiment, the controller of the coating system writes the roll change signal into the first storage address, and the statistical process control system can automatically acquire the roll change signal from the first storage address and automatically send a processing request for film roll numbers to the manufacturing execution system, thereby automatically completing the process of acquiring the first film roll number, and improving the degree of automation of the entire process. By setting the statistical process control system to automatically read the first storage data from the first storage address, the creation time of the film roll sheet can be shortened, coating process scenes with relatively high real-time requirements can be met, and the consistency between the production process information in the film roll sheet and the film roll can be improved.

In some embodiments, the coating system further includes: a cutter apparatus; and
the controller, configured to generate the roll change signal after detecting the automatic disconnecting operation of the cutter apparatus, and write the roll change signal into the first register.

Through the above processing mode, automatic generation of the roll change signal can be achieved, and the roll change signal is automatically stored to enable the statistical process control system to successfully acquire the roll change signal, so that the creation time of the film roll sheet can be shortened, coating process scenes with relatively high real-time requirements can be met, and the consistency between the production process information in the film roll sheet and the film roll can be improved.

In some embodiments, the statistical process control system is configured to:
read the first storage data in the first storage address according to a preset time interval, wherein the storage duration of the first storage data in the first storage address is greater than the preset time interval.

By setting the storage duration of the first storage data in the first storage address, the problem of repeatedly sending the processing request to the manufacturing execution system due to repeated reading of the roll change signal can be alleviated. By setting the preset time interval to be less than the storage duration of the first storage data in the first storage address, the probability of successfully reading the roll change signal from the first storage address can be increased.

In some embodiments, the coating system further includes:
a detection device, configured to detect production process information of the target film roll during the coating process; and
the statistical process control system, configured to acquire the production process information of the target film roll returned by the detection device based on a data transmission signal, store the production process information into a target cache space in the case of detecting that the creation of the first film roll sheet is not completed, and store the production process information cached in the target cache space into the first film roll sheet in the case of detecting that the creation of the first film roll sheet is completed.

In the above embodiment, in the case of detecting that the creation of the first film roll sheet is not completed, more comprehensive production process information can be obtained by caching the production process information in the target cache space, thereby improving the comprehensiveness and reliability of the production process information in the first film roll sheet.

In some embodiments, the detection device includes: a surface density meter and a dimension measurement system.

The surface density meter is configured to detect the density data of the substrate during the coating process.

The dimension measurement system is configured to detect real-time dimension data of each coating surface of the substrate during the coating process.

Through the above processing mode, the production process information of the target film roll during the coating process can be acquired in real time, thereby achieving the automatic storage of the production process information, improving the degree of automation of the entire process, saving the labor cost, and reducing errors caused by manual operation.

In some embodiments, the statistical process control system is configured to:
determine the request number of the first film roll number; and
generate the processing request based on the request number.

By setting the request number of the first film roll number, at least one first film roll number can be requested from the manufacturing execution system each time, thereby improving the flexibility of requesting the first film roll number to meet different production needs.

In some embodiments, the manufacturing execution system is configured to:
parse the processing request to acquire the number of requested film roll numbers, so as to obtain the request number; and
generate the request number of the first film roll numbers.

By setting the request number of the first film roll number, at least one first film roll number can be requested from the manufacturing execution system each time, thereby improving the flexibility of requesting the first film roll number to meet different production needs.

In some embodiments, the manufacturing execution system is configured to:
determine the attribute information of the coating machine and the coating attributes of the target film roll in the processing request; and
generate the first film roll number of the target film roll based on the attribute information of the coating machine and the coating attributes of the target film roll.

Through the above processing mode, the attribute information of the coating machine and the coating attributes of the target film roll can be more intuitively reflected through the film roll number, thereby accelerating the tracing speed of film rolls, and increasing the success rate of film roll tracing.

In some embodiments,
the statistical process control system is configured to determine a second film roll number in the case of determining that the substrate to be coated contains a coated surface, and send a processing request carrying the second film roll number to the manufacturing execution system, wherein the second film roll number is the film roll number obtained during the coating process of the coated surface, and the substrate to be coated is the substrate that needs to be coated after being connected to the target film roll; and
the manufacturing execution system is configured to generate the first film roll number and establish an association relationship between the first film roll number and the second film roll number.

Through the above processing mode, film roll sheets generated during the coating process on each coating surface of the substrate can be associated, thereby achieving the association of production process information, and ensuring quick and accurate traceability of film rolls during battery production.

According to a seventh aspect, an embodiment of the present application provides a coating method applied to the statistical process control system of the coating system according to the sixth aspect above. The coating method includes:
sending a processing request for film roll numbers to the manufacturing execution system in response to a roll change signal from the controller; and
acquiring a first film roll number of a target film roll sent by the manufacturing execution system based on the processing request, and creating a first film roll sheet based on the first film roll number, wherein the first film roll sheet is used to record the production process information of the target film roll during the coating process.

In the technical solution of the embodiment of the present application, the above processing does not require the manual input of film roll numbers, and also does not require the creation of a film roll sheet based on manually inputted film roll numbers. By means of automatically acquiring the first film roll number from the manufacturing execution system of the coating machine in response to the roll change signal, the process of acquiring the first film roll number can be automatically completed, and the process of creating the first film roll sheet can be automatically completed, thereby improving the degree of automation of the entire process, saving the labor cost, also improving the consistency between the first film roll sheet and the roll stock, and reducing the errors caused by manual operation.

In some embodiments, the coating method further includes:
sending data update information to the controller in response to the roll change signal, wherein the data update information is used to indicate that the first data in the first storage address is updated to second data, and the second data is used to indicate that the statistical process control system successfully reads the roll change signal.

In the above embodiment, by sending the data update information to the controller of the coating machine, the controller is prompted to modify the first data to the second data according to the data update information, which can achieve timely updating of the roll change signal, thereby alleviating the problem of repeatedly sending processing requests to the manufacturing execution system due to repeated reading of the roll change signal.

In some embodiments, the coating method further includes:
sending a data transmission signal carrying the first film roll number to a detection device, wherein the detection device is configured to detect the production process information of the target film roll during the coating process.

In the above embodiment, by means of sending the data transmission signal carrying the first film roll number to the detection device, the production process information transmitted by the detection device can be the production process information of the target film roll corresponding to the first film roll sheet, thereby improving the consistency between the production process information in the first film roll sheet and the target film roll.

In some embodiments, the coating method further includes:
acquiring the production process information of the target film roll returned by the detection device based on the data transmission signal;
storing the production process information into a target cache space in the case of detecting that the creation of the first film roll sheet is not completed; and storing the production process information cached in the target cache space into the first film roll sheet in the case of detecting that the creation of the first film roll sheet is completed.

In the above embodiment, in the case of detecting that the creation of the first film roll sheet is not completed, more comprehensive production process information can be obtained by caching the production process information in the target cache space, thereby improving the comprehensiveness and reliability of the production process information in the first film roll sheet.

In some embodiments, the sending a processing request for film roll numbers to the manufacturing execution system of the coating machine includes:
determining a second film roll number in the case of determining that the substrate to be coated contains a coated surface, wherein the second film roll number is the film roll number obtained during the coating process of the coated surface, and the substrate to be coated is the substrate that needs to be coated after being connected to the target film roll; and
sending a processing request carrying the second film roll number to the manufacturing execution system, wherein the processing request is used to request the generation of the first film roll number and establish an association relationship between the first film roll number and the second film roll number.

Through the above processing mode, film roll sheets generated during the coating process on each coating surface of the substrate can be associated, thereby achieving the association of production process information, and ensuring quick and accurate traceability of film rolls during battery production.

According to an eighth aspect, the present application provides a coating method applied to the manufacturing execution system of the coating system according to the sixth aspect above. The method includes:
generating a first film roll number of a target film roll in response to a processing request for film roll numbers sent by the statistical process control system; and
sending the first film roll number to the statistical process control system, wherein the first film roll number is used to create a first film roll sheet of the target film roll, and the first film roll sheet is used to record the production process information of the target film roll during the coating process.

In the technical solution of the embodiment of the present application, the first film roll number of the target film roll can be generated after detecting the processing request for film roll numbers sent by the statistical process control system of the coating machine, and the first film roll number is sent to the statistical process control system, wherein the first film roll number is used to create a first film roll sheet of the target film roll, and the first film roll sheet is used to record the production process information of the target film roll during the coating process. The above processing does not require the manual input of film roll numbers, and also does not require the creation of a film roll sheet based on manually inputted film roll numbers. By means of generating the first film roll number of the target film roll in response to the processing request for film roll numbers sent by the statistical process control system and automatically returning the first film roll number to the statistical process control system, the process of generating the first film roll number can be automatically completed, and the process of creating the first film roll sheet can be automatically completed, thereby improving the degree of automation of the entire process, saving the labor cost, also improving the consistency between the first film roll sheet and the roll stock, and reducing the errors caused by manual operation.

In some embodiments, the coating method further includes:
generating the first film roll number in response to a processing request for film roll numbers sent by the statistical process control system, and determining a second film roll number, wherein the second film roll number is the film roll number generated during the coating process of the coated surface of the substrate to be coated, and the substrate to be coated is the substrate that needs to be coated after being connected to the target film roll; and
establishing an association relationship between the first film roll number and the second film roll number.

Through the above processing mode, film roll sheets generated during the coating process on each coating surface of the substrate can be associated, thereby achieving the association of production process information, and ensuring quick and accurate traceability of film rolls during battery production.

According to a ninth aspect, the present application provides an electronic device, including a memory, a processor, and a computer program stored in the memory and capable of running on the processor. The processor executes the program to implement the method according to any of the first aspect, the fourth aspect, the fifth aspect, the seventh aspect, and the eighth aspect.

According to a tenth aspect, the present application provides a computer-readable storage medium storing a computer program. The program is executed by a processor to implement the method according to any of the first aspect, the fourth aspect, the fifth aspect, the seventh aspect, and the eighth aspect.

According to an eleventh aspect, the present application provides a computer program product, including a computer program. The computer program is executed by a processor to implement the method according to any of the first aspect, the fourth aspect, the fifth aspect, the seventh aspect, and the eighth aspect.

The foregoing descriptions are merely an overview of the technical solutions of the present application. To understand the technical means of the present application more clearly, implementation can be performed according to the content of the specification. Moreover, to make the foregoing and other objectives, features and advantages of the present application more comprehensible, specific embodiments of the present application are particularly described below.

### DESCRIPTION OF DRAWINGS

In order to illustrate the technical solutions in the embodiments of the present application more clearly, the following briefly introduces the accompanying drawings required in the embodiments. The accompanying drawings herein are incorporated into the specification and constitute a part of the specification. These accompanying drawings illustrate the embodiments conforming to the present application, and are intended to explain the technical solutions of the present application together with the specification. It should be understood that the following accompanying drawings only show some embodiments of the present application, and therefore should not be considered as limiting the scope of the present application. Those of ordinary skill in the art can also obtain other relevant accompanying drawings according to these accompanying drawings without creative efforts.

FIG. 1 is a schematic flowchart of a method for generating film roll sheets according to one or more embodiments.

FIG. 2 is a schematic structural diagram of a single-layer coating machine according to one or more embodiments.

FIG. 3 is a schematic structural diagram of a double-layer coating machine according to one or more embodiments.

FIG. 4 is a schematic effect diagram of a mode selection page according to one or more embodiments.

FIG. 5 is a schematic effect diagram of a function setting page in a home page of a statistical process control (SPC) system according to one or more embodiments.

FIG. 6 is a schematic effect diagram of a main function page in a home page of an SPC system according to one or more embodiments.

FIG. 7 is a schematic effect diagram of a first page in a normal mode according to one or more embodiments.

FIG. 8 is a schematic effect diagram of a first page in a manual mode according to one or more embodiments.

FIG. 9 is a schematic effect diagram of a first page in an automatic mode according to one or more embodiments.

FIG. 10 is a schematic effect diagram of a second page in a fully-automatic mode according to one or more embodiments.

FIG. 11 is a schematic effect diagram of a third page according to one or more embodiments.

FIG. 12 is a schematic structural diagram of a system for generating film roll sheets according to one or more embodiments.

FIG. 13 is a schematic structural diagram of an apparatus for generating film roll sheets according to one or more embodiments.

FIG. 14 is a schematic structural diagram of a coating system according to one or more embodiments.

FIG. 15 is a schematic flowchart of a coating method according to one or more embodiments.

FIG. 16 is another schematic flowchart of a coating method according to one or more embodiments.

FIG. 17 is still another schematic flowchart of a coating method according to one or more embodiments.

FIG. 18 is a schematic diagram of electrode plate dimension data according to one or more embodiments.

FIG. 19 is a schematic structural diagram of another coating system according to one or more embodiments.

FIG. 20 is a schematic structural diagram of still another coating system according to one or more embodiments.

FIG. 21 is a schematic flowchart of a coating method according to one or more embodiments.

FIG. 22 is a schematic flowchart of another coating method according to one or more embodiments.

FIG. 23 is a schematic flowchart of still another coating method according to one or more embodiments.

FIG. 24 is a structural block diagram of an electronic device according to one or more embodiments.

FIG. 25 is a schematic diagram of a computer-readable storage medium according to one or more embodiments.

### DETAILED DESCRIPTION

The embodiments of the technical solutions of the present application will be described in detail below with reference to the accompanying drawings. The following embodiments are only used to illustrate the technical solutions of the present application more clearly, and thus are only interpreted as examples, rather than used to limit the scope of protection of the present application.

Unless otherwise defined, all technical and scientific terms used herein have the same meanings as those commonly understood by those skilled in the art of the present application. The terms used herein are intended only for the purpose of describing specific embodiments and are not intended to limit the present application. The terms “including” and “having” and any variations thereof in the specification and claims of the present application and in the description of the above accompanying drawings are intended to cover non-exclusive inclusion.

In the description of the embodiments of the present application, the technical terms “first”, “second”, etc., are only used for distinguishing different objects, and cannot be understood as indicating or implying relative importance or implying the number, specific order or primary and secondary relationship of the technical features indicated. In the description of the embodiments of the present application, the meaning of “a plurality of” is two or more (including two), unless otherwise explicitly and specifically defined.

The “embodiment” mentioned herein means that specific features, structures, or characteristics described with reference to the embodiment may be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiments of the present application, the term “and/or” is simply a description of an association relationship between associated objects, which indicates that there may have three relationships, for example, A and/or B may mean: the presence of A, the presence of both A and B, and the presence of B. In addition, the character “/” herein generally means that there is an “or” relationship between associated objects therebefore and thereafter.

With the increasingly tense global energy and environmental situation, batteries are gaining popularity as a power source, and are becoming the preferred choice for the development of power batteries. In various production stages of batteries, a coating process is a process flow during battery production. A battery coating process refers to uniformly coating the prepared slurry onto the surface of a metal foil, and then drying the surface to respectively prepare positive and negative electrode plates.

Specifically, a substrate can be placed on an unwinding apparatus, and after automatic correction, the substrate enters a coating head. The coating head can coat the substrate with coating slurry according to a set program of a coating system. A coated wet electrode plate enters a coating oven and is dried with hot air. The tension of the dried electrode plate is adjusted by a tension swing roller, while the winding speed of the winding apparatus is controlled to synchronize the winding speed with the coating speed. The dried electrode plate is automatically corrected by a correction system and kept in a center position, and then wound by the winding apparatus.

Before coating the substrate, a corresponding number can usually be assigned to the substrate. Then, before coating the substrate, the number can be manually inputted into the control system of the coating machine. The control system then sets a coating sheet for the substrate, and records film roll data during the battery coating process through the coating sheet.

During the battery coating process, the film roll data is usually created manually. The manner for creating film roll data manually is relatively limited, has relatively low creation efficiency of film roll data, and has the risk of manually inputting incorrect information. Therefore, the manner for creating film roll data cannot meet coating process scenes with relatively high real-time requirements and accuracy requirements.

Based on the above research, an embodiment of the present application provides a method for generating film roll sheets. In the method, a parameter processing mode of film roll parameters is acquired through a mode selection page, wherein the parameter processing mode is used to indicate a parameter acquisition manner of the film roll parameters in the current operating state of a coating machine; the parameter content of the film roll parameters is acquired according to the parameter acquisition manner indicated by the parameter processing mode; and a new film roll sheet is generated based on the parameter content, wherein the new film roll sheet is used to record coating process parameters of a substrate.

In this embodiment, the parameter processing mode of the film roll parameters can be acquired, thereby acquiring the parameter acquisition manner of the film roll parameters in the current operating state of the coating machine. Then, the parameter content of the film roll parameters can be acquired according to the parameter acquisition manner indicated by the parameter processing mode, thereby generating the new film roll sheet based on the parameter content. The above processing mode can select the parameter acquisition manner of the film roll parameters according to the current operating state of the coating machine, thereby selecting the parameter acquisition manner that is more compatible with the current operating state of the coating machine to meet different operating states of the coating machine. The manner for acquiring the parameter processing mode through the mode selection page can also enrich the parameter acquisition manner of the film roll parameters, so as to meet coating process scenes with relatively high real-time requirements and accuracy requirements.

The batteries in the embodiments of the present application may be lithium-ion batteries, lithium metal batteries, etc., such as lithium cobalt oxide batteries, lithium manganate batteries, lithium nickel cobalt manganese oxide batteries, lithium nickel cobalt aluminum oxide batteries, lithium iron phosphate batteries, lithium titanate batteries, and lithium-sulfur batteries. Or, the batteries in the embodiments of the present application may include, but are not limited to, batteries of other material systems, such as lead-acid batteries, nickel-chromium batteries, nickel-hydrogen batteries, or sodium-ion batteries.

In some embodiments of the present application, the devices involved in the method for generating film roll sheets may include, but are not limited to, the process control system of the coating machine and the coating machine. The process control system may include, but is not limited to, a device that performs statistical analysis and evaluation of the production process of the coating machine. Here, the process control system and the coating machine are connected, and the connection relationship between the process control system and the coating machine may be wired connection, wireless connection, or the like.

In these embodiments, the process control system can provide the mode selection page, and the parameter processing mode of the film roll parameters can be acquired through the mode selection page, thereby acquiring the parameter acquisition manner of the film roll parameters in the current operating state of the coating machine; then, the process control system can acquire the parameter content of the film roll parameters according to the parameter acquisition manner indicated by the parameter processing mode; and a new film roll sheet is generated based on the parameter content, wherein the new film roll sheet is used to record coating process parameters of a substrate. The above processing mode can select the parameter acquisition manner of the film roll parameters according to the current operating state of the coating machine, thereby selecting the parameter acquisition manner that is more compatible with the current operating state of the coating machine to meet different operating states of the coating machine. The manner for acquiring the parameter processing mode through the mode selection page can also enrich the parameter acquisition manner of the film roll parameters, so as to meet coating process scenes with relatively high real-time requirements and accuracy requirements.

For ease of description, the specific processes of the embodiments of the present application will be described in detail below by the involved device, including a process control system, as an example.

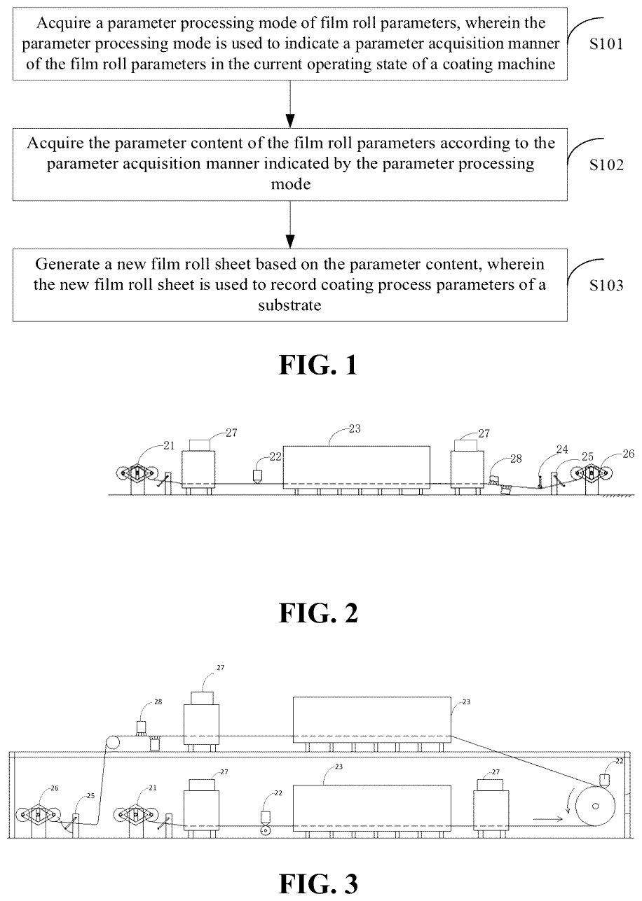

Referring to FIG. 1, an embodiment of the present application provides a method for generating film roll sheets. The method specifically includes the following steps:

Step 101: A parameter processing mode of film roll parameters is acquired, wherein the parameter processing mode is used to indicate a parameter acquisition manner of the film roll parameters in the current operating state of a coating machine.

In this embodiment of the present application, the coating machine includes a controller of the coating machine, an unwinding apparatus of the coating machine, a coating die head, a coating oven, a winding apparatus of the coating machine, a statistical process control system, and a manufacturing execution system.

Here, the statistical process control system may be a statistical process control (SPC) system, and the manufacturing execution system may be a manufacturing execution system (MES) or the like. The controller of the coating machine includes, but is not limited to, a programmable logic controller (PLC). The MES is configured to generate film roll parameters and provide the film roll parameters to the SPC system.

In the following embodiments, the statistical process control system is referred to as an SPC system, and the manufacturing execution system is referred to as an MES.

Here, the coating machine may be a single-layer coating machine or a double-layer coating machine. FIG. 2 is a schematic structural diagram of a single-layer coating machine. FIG. 3 is a schematic structural diagram of a double-layer coating machine.

As shown in FIG. 2, the single-layer coating machine includes an unwinding apparatus 21, a single-sided coating die head 22, coating ovens 23, a tension swing roller 24, a cutter apparatus 25, a winding apparatus 26, a surface density meter 27, and a dimension measurement system 28. As shown in FIG. 3, the double-layer coating machine includes an unwinding apparatus 21, double-sided coating dies 22 (i.e., the first-sided coating die 22 and the second-sided coating die 22 in FIG. 3), two coating ovens 23 (i.e., the first-sided coating oven 23 and the second-sided coating oven 23 in FIG. 3), a cutter apparatus 25, a winding apparatus 26, a surface density meter 27, and a dimension measurement system 28.

As shown in FIG. 2 and FIG. 3, a substrate can be placed on the unwinding apparatus, and after automatic correction, the substrate enters the coating die head. The coating die head can coat the substrate with coating slurry according to a set program. A wet electrode plate obtained by coating enters the coating oven and is dried with hot air. The tension of the dried electrode plate is adjusted by the tension swing roller, while the winding speed of the winding apparatus is controlled to synchronize the winding speed with the coating speed. The dried electrode plate is automatically corrected by a correction system and kept in a center position, and then wound by the winding apparatus.

Here, the mode selection page is a page provided by the SPC system for selecting parameter processing modes. The mode selection page contains multiple candidate processing modes. At this time, the selected candidate processing mode can be determined as the parameter processing mode according to a selection event detected on the mode selection page.

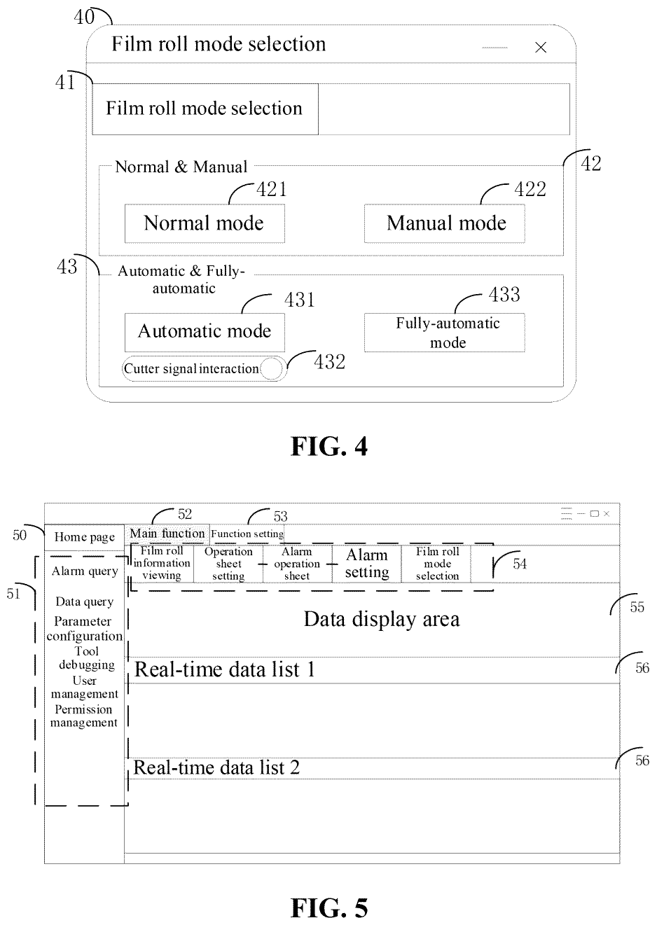

FIG. 4 shows the mode selection page 40. As can be seen from FIG. 4, the mode selection page 40 includes a display component 41 for film roll mode selection, and display components 42 and 43 for candidate processing modes. The candidate processing modes include: a normal mode 421, a manual mode 422, automatic modes 431 and 432 with cutter signal interaction, and a fully-automatic mode 433. FIG. 5 shows a “Function Setting 53” page in a home page 50 of the SPC system. As shown in FIG. 5, the home page contains “Main Function 52” and “Function Setting 53” pages. In addition, the home page 50 also includes functions 51 which include, but are not limited to, the following functions: alarm query, data query, parameter configuration, tool debugging, user management, and permission management. As shown in FIG. 5, the “Function Setting 53” page includes settings 54 which include, but are not limited to, the following: film roll information viewing, operation sheet setting, alarm operation sheet, alarm setting, and film roll mode selection. As shown in FIG. 5, the home page includes a data display area 55 and a display area for implementing a data list 56.

After a trigger operation for a “Film Roll Mode Selection” button in the “Function Setting” page is detected, the mode selection page shown in FIG. 4 can be displayed in the home page, thereby realizing the parameter processing mode of acquiring film roll parameters through the mode selection page.

Through the parameter processing mode, the parameter acquisition manner of the film roll parameters in the current operating state of the coating machine can be determined, wherein the parameter processing mode can be understood as a mode that can adapt to the current operating state and accurately and quickly acquire the film roll parameters. The parameter acquisition manner can be understood as one or more operations for acquiring film roll parameters in the parameter processing mode.

Here, the current operating state of the coating machine can be used to indicate the connection state among the SPC system, the MES and the PLC. The film roll parameters include film roll number, substrate weight, and other parameters.

In this embodiment of the present application, the film roll number may include, but is not limited to, the following: position information, time information, coating surface information, and indicator, wherein the position information is used to indicate the position of the coating machine; the coating surface information is used to indicate the information of the coating surface of the coating machine; the time information is used to indicate the production date of the coating slurry and the coating date of the substrate; and the indicator is an indicator generated according to the sending order of the processing request. Here, the film roll number is a carrier of film roll related information, and material identification and tracing can be achieved through the film roll number.

In this embodiment of the present application, when the diameter of the film roll wound by the winding apparatus of the coating machine is detected to reach a set value, a roll change signal is generated. At this time, the winding apparatus of the coating machine is automatically disconnected and connected to a new film roll drum. After the process control system detects the roll change signal of the coating machine, a processing request for film roll numbers can be sent to the film roll management system of the coating machine.

Here, if the SPC system, the MES and the PLC can communicate normally, the current operating state of the coating machine is determined to be a normal operating state. If there is an abnormal communication link among the SPC system, the MES and the PLC, the current operating state of the coating machine is determined to be an abnormal operating state.

For example, if the communication between the SPC system and the MES is abnormal, the SPC system will be unable to acquire the film roll number from the MES. In this case, in order to maintain the normal operation of the coating machine, it is necessary to set a parameter processing mode that matches the current operating state, so that the film roll parameters can be acquired in various operating states of the coating machine.

Step 102: The parameter content of the film roll parameters is acquired according to the parameter acquisition manner indicated by the parameter processing mode.

Step 103: A new film roll sheet is generated based on the parameter content, wherein the new film roll sheet is used to record coating process parameters of a substrate.

After the parameter processing mode is acquired, the parameter content of the film roll parameters can be acquired according to the parameter acquisition manner indicated by the parameter processing mode.

After acquiring the parameter content, the process control system can create a new film roll sheet based on the parameter content. Here, a film roll sheet template that matches the coating machine can be acquired from a film roll sheet template library; and the name of the film roll sheet template is determined based on the parameter content to obtain a new film roll sheet.

Here, the new film roll sheet is used to record coating process parameters of the substrate during the coating process. The coating process parameters include, but are not limited to, information such as production base, workshop, machine, date, formula, time, weight data and real-time dimension data of the substrate during the coating process, and process parameters of the coating machine. Here, the weight data includes the substrate weight before coating, the substrate weight after the first surface of the substrate is coated, and the substrate weight after the first and second surfaces of the substrate are coated.

Here, the first surface and the second surface are two opposite coating surfaces of the substrate. Usually, the first surface is referred to as a surface A, and the second surface is referred to as a surface B.

In the technical solution of this embodiment of the present application, the parameter processing mode of the film roll parameters can be acquired, thereby acquiring the parameter content of the film roll parameters according to the parameter acquisition manner indicated by the parameter processing mode, and generating a new film roll sheet according to the parameter content. The above processing mode can select the parameter acquisition manner of the film roll parameters according to the current operating state of the coating machine, thereby selecting the parameter acquisition manner that is more compatible with the current operating state of the coating machine to meet different operating states of the coating machine. The manner for acquiring the parameter processing mode through the mode selection page can also enrich the parameter acquisition manner of the film roll parameters, so as to meet coating process scenes with relatively high real-time requirements and accuracy requirements.

In some embodiments of the present application, the acquiring the parameter content of the film roll parameters according to the parameter acquisition manner indicated by the parameter processing mode includes the following steps:
a first page corresponding to the parameter processing mode is displayed based on a detected film roll sheet creation request, wherein the parameter acquisition manner indicated by the parameter processing mode includes acquisition through the first page; and the parameter content of the film roll parameters is acquired through the first page.

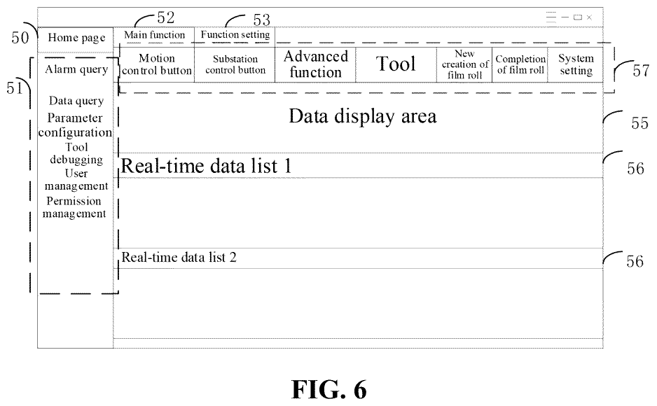

FIG. 6 shows a “Main Function 52” page of a home page of the SPC system. As shown in FIG. 6, the home page contains “Main Function 52” and “Function Setting 53” pages. In addition, the home page 50 also includes functions 51 which include, but are not limited to, the following functions: alarm query, data query, parameter configuration, tool debugging, user management, and permission management. As shown in FIG. 6, the “Main Function 53” page includes function content 57 which includes, but is not limited to, the following: motion control button, substation control button, advanced function, tool, new creation of film roll, completion of film roll, and system setting. As shown in FIG. 6, the home page includes a data display area 55 and a display area for implementing a data list 56.

After detecting a trigger operation for “New Creation of Film Roll” in the main function page, it is determined that a film roll sheet creation request is detected. Then, in the case of determining that the parameter processing mode is a “Normal Mode”, a “Manual Mode”, or an “Automatic Mode” with cutter signal interaction, the first page corresponding to the parameter processing mode will be displayed.

Here, the first page can be understood as a parameter acquisition page for film roll parameters, and the parameter acquisition manners indicated by different parameter processing modes are different. At this time, one or more operations for displaying the selected parameter acquisition manner can be acquired through the first page. In other words, the first page corresponding to the parameter processing mode contains one or more operations of the parameter acquisition manner.

Here, the first page includes, but is not limited to, the following components: a display component for input information 61, a display component for a parameter processing mode 62, and a display component for a film roll creation area 63 of the current film roll to be created. The creation area includes a parameter editing area 631 and a confirmation area 632.

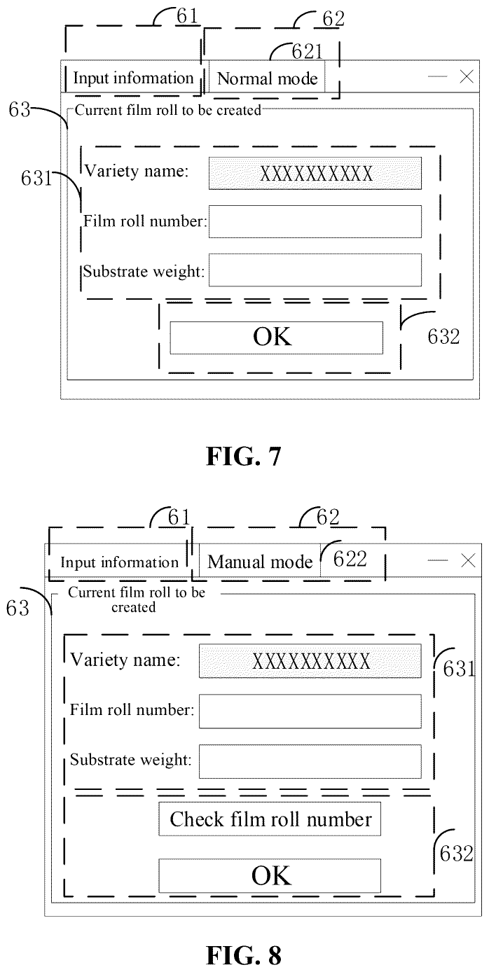

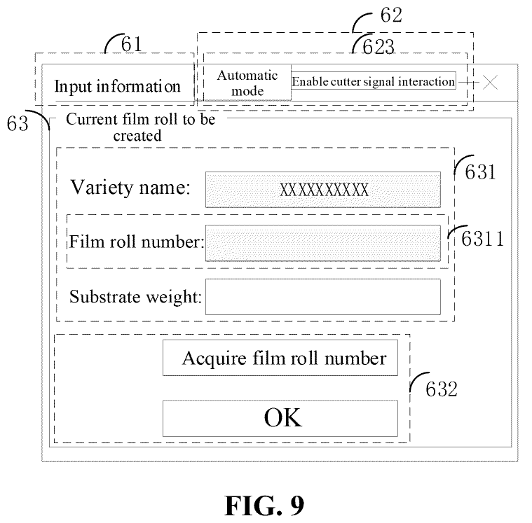

For example, FIG. 7 shows a first page corresponding to a “Normal Mode”. As shown in FIG. 7, the parameter processing mode 62 is a normal mode 621, the confirmation area 632 contains an “OK” button, and the parameter editing area 631 includes editing areas for the following parameters: variety name, film roll number, and substrate weight. FIG. 8 shows a first page corresponding to a “Manual Mode”. As shown in FIG. 8, the parameter processing mode 62 is a manual mode 622, the confirmation area 632 contains an “OK” button and a “Check Film Roll Number” button, and the parameter editing area 631 includes editing areas for the following parameters: variety name, film roll number, and substrate weight. FIG. 9 shows a first page corresponding to an “Automatic Mode”. As shown in FIG. 9, the parameter processing mode 62 is an automatic mode 623 with cutter signal interaction, the confirmation area 632 contains an “OK” button and a “Film Roll Number Acquisition” button, and the parameter editing area 631 includes editing areas for the following parameters: variety name, film roll number, and substrate weight. From FIG. 7 to FIG. 9, it can be seen that for different parameter processing modes, one or more operations for the parameter acquisition manner displayed in the first page are also different.

After determining the first page corresponding to the parameter processing mode, the parameter content of the film roll parameters can be acquired through the first page.

In the above embodiment, by displaying the first page corresponding to the parameter processing mode and acquiring the parameter content through the first page, the flexibility of acquiring the film roll parameters can be improved, thereby meeting various operating states of the coating machine.

In some embodiments of the present application, the acquiring the parameter content of the film roll parameters through the first page includes the following steps:
a parameter editing area of the film roll parameters is displayed through the first page; and the parameter content of the film roll parameters is determined in response to the edited content in the parameter editing area.

For both the “Normal Mode” and the “Manual Mode”, the first page contains a parameter editing area for film roll parameters. As shown in FIG. 7 and FIG. 8, there is a parameter editing area containing a batch number-roll number (i.e., film roll number) and a parameter editing area containing substrate weight, wherein the parameter editing area is an editable area.

At this time, the edited content in the parameter editing area can be detected, and the parameter content of the film roll parameters can be determined according to the edited content. For example, as shown in FIG. 7, for “Normal Mode”, the edited content in the parameter editing area can be directly determined as the parameter content of the film roll parameters. After a trigger operation for an “OK” button in FIG. 7 is detected, a new film roll sheet can be generated based on the parameter content of the film roll parameters.

In the above embodiment, the manner for acquiring the parameter content of the film roll parameters through the parameter editing area can more flexibly acquire the parameter content, so as to meet various operating states of the coating machine.

In some embodiments of the present application, the generating a new film roll sheet based on the parameter content includes the following steps:
validity check is performed on the parameter content in the case of detecting a parameter check event to obtain a check result; and the new film roll sheet is generated based on the parameter content in the case of determining that the check result is successful.

In the embodiments of the present application, the “Normal Mode” is applicable to device debugging scenes. For example, when the coating machine is debugged, the debugging of the device can be implemented through the “Normal Mode”. From the above description, it can be seen that in the “Normal Mode”, the film roll number and substrate weight need to be manually inputted, and then, the “OK” button is manually clicked to create a new film roll sheet. The “Manual Mode” is applicable to situations where there is a communication failure between the SPC system and the MES, or a failure to issue film roll numbers. In the “Manual Mode”, the film roll number and substrate weight need to be manually inputted. In order to improve the accuracy of the film roll number, the inputted film roll number and substrate weight need to be checked before a new film roll sheet is created.

As shown in FIG. 8, after a trigger operation for a “Check Film Roll Number” button in the first page is detected, it is determined that a parameter check event is detected. At this time, the validity check can be performed on the parameter content inputted by the user, thereby obtaining a check result.

In an optional embodiment, the SPC system can send the parameter content to be checked to the MES. After the MES successfully checks the parameter content to be checked, a successful check result is fed back to the SPC system. In this case, the “OK” button in the first page, as shown in FIG. 8, will become a button that can be triggered. After a trigger operation for an “OK” button in FIG. 8 is detected, a new film roll sheet can be generated based on the parameter content of the film roll parameters.

In another optional embodiment, the SPC system can perform validity check on the parameter content to be checked, and can obtain a successful check result in the case of successful check. In this case, the “OK” button in the first page, as shown in FIG. 8, will become a button that can be triggered. After a trigger operation for an “OK” button in FIG. 8 is detected, a new film roll sheet can be generated based on the parameter content of the film roll parameters.

In some embodiments of the present application, the performing validity check on the parameter content in the case of detecting a parameter check event to obtain a check result includes:
the content length of the parameter content is checked to obtain a first sub-check result;
various components of the parameter content are checked to obtain a second sub-check result; and
the check result is obtained based on the first sub-check result and the second sub-check result.

Here, the performing validity check on the parameter content specifically includes the following check modes:
validity check is performed on the content length of the parameter content, and a successful check result is obtained in the case of determining that the content length meets the preset length requirement; and
validity check is performed on various components of the parameter content, and a successful check result is obtained in a case that the check result of various components is successful.

Here, various components of the parameter content to be checked can be compared with the preset content. In a case that the comparison results are consistent, it is determined that the check is successful. For example, for the position information in the parameter content, the content length of the position information can be compared with the preset length of the position information. If it is determined that the content length and the preset length are the same, it is determined that the preset length requirement is met, and a successful length check result is obtained. Then, whether the components of the position information are correct is checked, wherein if the check is correct, it is determined that the check result of the components of the position information is successful, and a successful check result is obtained.

In the above embodiment, by performing validity check on the parameter content, errors in film roll numbers caused by human error operations can be reduced, thereby improving the accuracy of the film roll numbers.

In some embodiments of the present application, the method further includes the following steps:
a check display identifier in the first page is controlled to be switched from a first display state to a second display state in the case of determining that the check result is successful, wherein the second display state is used to indicate that the check result is successful.

Here, the check display identifier may be the “OK” button shown in FIG. 8, and may also be a check display identifier set in other areas of the confirmation area 632 in the first page.

During the check of the parameter content, the check display identifier is in the first display state, for example, the “OK” button is not clickable. After the check is successful, the check display identifier is in the second display state, for example, the “OK” button is clickable. In a case that the check is not successful, the check display identifier remains in the first display state without changing.

In some embodiments of the present application, the acquiring the parameter content of the film roll parameters through the first page includes the following steps:

a parameter display area of the film roll parameters and an acquisition identifier of the film roll parameters are displayed through the first page; an acquisition request is sent to a film roll management system in the case of detecting a trigger event for the acquisition identifier; and the parameter content returned by the film roll management system based on the acquisition request is acquired, and the parameter content is displayed in the parameter display area.

In a case that the parameter processing mode is the “Automatic Mode”, the first page may be the page shown in FIG. 9. Here, the “Automatic Mode” is suitable for scenes where a cutter signal fails and the substrate weight changes frequently.

As shown in FIG. 9, the first page contains a parameter display area of film roll parameters, namely an area 1 numbered as 6311 in FIG. 9. The parameter display area is a non-editable area. The first page also includes an acquisition identifier for film roll parameters, namely the “Acquire Film Roll Number” button in FIG. 9.

In a case that an “Acquire Film Roll Number” button in FIG. 9 is detected, it is determined that a trigger event for the acquisition identifier is detected. Then, an acquisition request for film roll numbers can be sent to the film roll management system, such as the MES. After the MES acquires the acquisition request, a new film roll number can be generated, and the new film roll number can be sent to the SPC system. After the SPC system acquires the new film roll number, the new film roll number can be displayed in the parameter display area.

If the film roll parameters include manually inputted parameters, the parameter editing area for the manually inputted parameters can also be displayed in the first page. For example, as shown in FIG. 9, the substrate weight is a manually inputted parameter. At this time, the parameter editing area for the substrate weight can be displayed in the first page, and thus, the weight content (i.e., parameter content) of the substrate weight can be determined based on the edited content in the parameter editing area.

In the above embodiment, the film roll numbers can be automatically acquired, thereby improving the degree of automation of the entire process, improving the accuracy of the film roll numbers, and also saving the labor cost.

In some embodiments of the present application, the generating a new film roll sheet based on the parameter content includes the following steps:
a roll change signal of the coating machine is detected according to a preset time interval in the case of determining that a target detection identifier indicates that the detection is enabled, wherein the target detection identifier is used to indicate whether to perform detection of the roll change signal; and the new film roll sheet is generated based on the parameter content in the case of detecting the roll change signal.

From the above description, it can be seen that an interactive button of cutter signals is carried in the automatic mode, wherein in a case that the interactive button indicates that the detection is enabled, it indicates that the SPC system needs to perform the step of detecting the roll change signal; and in a case that the interactive button indicates that the detection is disabled, it indicates that the SPC system does not need to perform the step of detecting the roll change signal. Here, the target detection identifier is denoted as the interactive button of cutter signals as shown in FIG. 9.

In this embodiment of the present application, in the case of detecting that the target detection identifier indicates that the detection is enabled, the roll change signal of the coating machine can be detected according to a preset time interval. In the case of detecting the roll change signal, a new film roll sheet is generated based on the parameter content acquired through the first page.

Here, when the PLC of the coating machine detects that the diameter of the film roll wound by the winding apparatus of the coating machine reaches a set value (such as 1.2 m), a roll change signal is generated, and the roll change signal is written into a register. The SPC system can detect the roll change signal in the register according to the preset time interval, and generate a new film roll sheet based on the parameter content in the case of detecting the roll change signal.

In this embodiment of the present application, a new film roll sheet can be generated based on the parameter content in the case of detecting that the target detection identifier indicates that the detection is disabled, and detecting a trigger event for an “OK” button in FIG. 9.

Through the above processing mode, a new film roll sheet can be automatically generated based on the parameter content, so that when a roll change apparatus performs a roll change operation, a new film roll sheet can be quickly generated, so as to record new coating process information.

In some embodiments of the present application, the acquiring the parameter content of the film roll parameters according to the parameter acquisition manner indicated by the parameter processing mode includes the following step:
the parameter content of the film roll parameters is acquired from a target management system in the case of detecting the roll change signal of the coating machine.

In this embodiment of the present application, when the parameter processing mode is a “Fully-Automatic Mode”, the roll change signal of the coating machine can be detected, and the parameter content of the film roll parameters is acquired from the target management system in the case of detecting the roll change signal.

Here, the “Fully Automatic Mode” refers to automatic acquisition of film roll parameters, thereby achieving automatic creation and completion of film roll sheets, and disallowing modification of the parameter content of the film roll parameters.

From the above description, it can be seen that when the PLC of the coating machine detects that the diameter of the film roll wound by the winding apparatus of the coating machine reaches a set value (such as 1.2 m), a roll change signal is generated, and the roll change signal is written into a register.

The SPC system can detect the roll change signal in the register according to the preset time interval, and send an acquisition request to the film roll management system (MES) in the case of detecting the roll change signal. After receiving the acquisition request, the MES can generate the parameter content of the film roll parameters and feed the parameter content back to the SPC system; and then, the SPC system can generate a new film roll sheet based on the parameter content. At this time, the MES is a target management system. The substrate weight and the variety name of the film roll can be automatically acquired from an operation sheet management setting module of the SPC. For example, the variety name can be determined according to the film roll sheet attributes set in the operation sheet management setting module.

Through the above processing mode, the process of acquiring film roll parameters can be automatically completed, and the process of creating film roll sheets can be automatically completed, thereby improving the degree of automation of the entire process, saving the labor cost, and reducing errors caused by manual operation.

In some other embodiments of the present application, on the basis of the technical solution described in the above embodiment, the method further includes the following step:

A second page is determined and displayed based on a detected parameter viewing request, and the parameter display area of the film roll parameters is displayed in the second page.

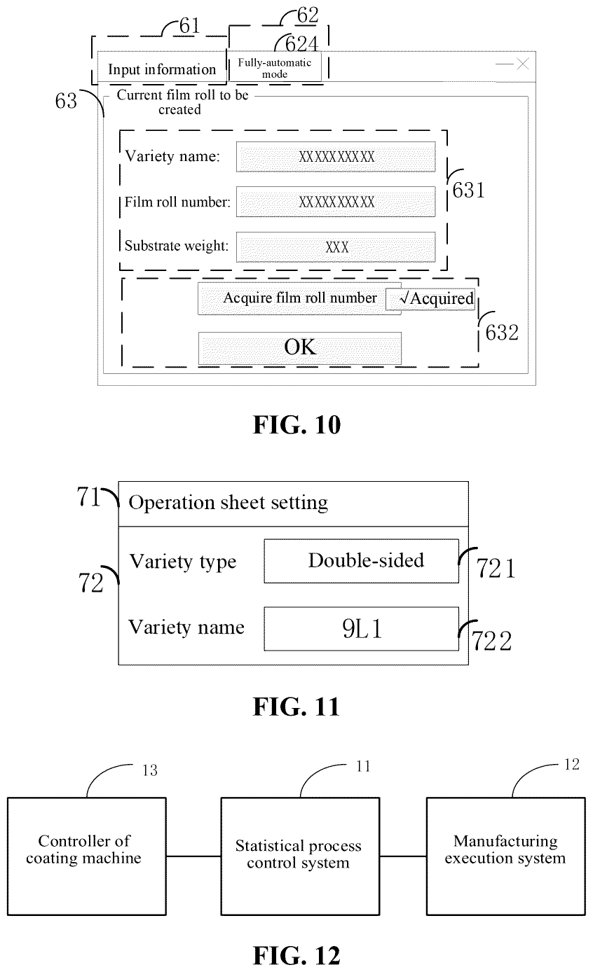

In this embodiment of the present application, in the “Fully-Automatic Mode”, if a click operation for a “Create New Film Roll” button in FIG. 6 is detected, it is determined that a parameter viewing request is detected. At this time, a second page can be determined and displayed, wherein the second page may be the page shown in FIG. 10. As shown in FIG. 10, the parameter processing mode 62 is the fully-automatic mode 624. The confirmation area 632 includes a “Confirm” button and an “Acquire Film Roll Number” button for indicating whether to acquire film roll numbers. The parameter editing area 631 includes editing areas of the following parameters: variety name, film roll number, and substrate weight. It can be seen from FIG. 10 that the second page is a parameter display area for displaying film roll parameters, wherein the parameter display area is a non-editable area. As shown in FIG. 10, in addition to displaying the parameter display area in the second page, an acquisition state of the film roll parameters can also be displayed.

Through the above processing mode, the acquired parameter content can be displayed, and setting the film roll parameters to be non-editable can reduce errors caused by manual operation.

In some embodiments of the present application, on the basis of the technical solution described in the above embodiment, the method further includes the following steps:
coating process parameters are stopped from being entered into the current film roll sheet in the case of detecting that the current film roll sheet is completed, the current film roll sheet is stored into a target storage space, and an operation of generating a new film roll sheet based on the parameter content is performed.

In this embodiment of the present application, before a new film roll sheet is generated, it is necessary to complete the current film roll sheet; and after the current film roll sheet is completed, the operation of generating a new film roll sheet based on the parameter content is performed.

Here, after it is detected that the current film roll sheet is completed, the SPC system can stop entering the coating process parameters of the substrate into the current film roll sheet, and then can also store the current film roll sheet into the target storage space, thereby completing the current film roll sheet.

For the “Normal Mode”, the “Manual Mode”, and the “Automatic Mode” with disabled cutter interaction signals, it can be determined that an instruction for completing the current film roll sheet is detected after a trigger operation for “Complete Film roll” in FIG. 6 is detected. For the “Automatic Mode” and the “Fully-Automatic Mode” with enabled cutter interaction signals, after the parameter content of the film roll parameters is acquired, the current film roll sheet can be automatically completed, and the operation of generating a new film roll sheet based on the parameter content can be performed.

Through the above processing mode, the entering accuracy of coating process parameters can be improved, and the consistency and traceability of a new film roll sheet and a film roll stock can be improved.

In some embodiments of the present application, on the basis of the technical solution described in the above embodiment, the method further includes the following steps:
a third page is displayed based on a detected input request of film roll sheet attributes, wherein the third page contains an attribute editing area; and film roll sheet attributes of the new film roll sheet are determined based on the edited content in the attribute editing area.

In this embodiment of the present application, in a case that the coating machine is a single-sided coating machine, the film roll sheet attributes need to be inputted before a new film roll sheet is generated based on the parameter content. In the case of detecting a trigger operation for an “Operation Sheet Setting” button in FIG. 5, it is determined that an input request for film roll attributes is detected. At this time, the third page shown in FIG. 11 can be displayed in the function setting page. The third page contains a display component of an operation sheet setting 71 and a display component of an attribute editing area 72.

For example, as shown in FIG. 11, the attribute editing area 72 is configured to display film roll sheet attributes, wherein the film roll sheet attributes include a variety type 721 and a variety name 722. The variety type can be understood as a coating surface of the coating machine, such as single-sided coating or double-sided coating, wherein the single-sided coating means coating the first surface of the substrate, and the double-sided coating means coating the second surface of the substrate. The variety name can be understood as the name of the film roll.

Through the above processing mode, due to coating characteristics of a single-sided coating machine, by means of setting film roll sheet attributes, coating process parameters of each coating surface can be accurately recorded.

In some other embodiments of the present application, on the basis of the technical solution described in the above embodiment, the method further includes the following steps:
a target film roll sheet of the coated surface is acquired in the case of determining that a substrate to be coated contains a coated surface based on the film roll sheet attributes; and an association relationship between the target film roll sheet and the new film roll sheet is established.

In this embodiment of the present application, for the single-sided coating machine, whether the substrate to be coated includes a coated surface can be determined according to the film roll sheet attributes. Here, whether the substrate to be coated includes a coated surface can be determined according to the variety type. If the variety type is double-sided coating, it is determined that the substrate to be coated includes the coated surface.

In the case of determining that the substrate to be coated includes the coated surface, it is necessary to acquire a target film roll sheet of the coated surface and establish an association relationship between the target film roll sheet and a new film roll sheet.

Here, in the case of determining that the substrate to be coated includes the coated surface, an electronic tag disposed on the substrate to be coated can be scanned by a tag scanning apparatus disposed in the coating machine, so as to obtain a film roll number of the target film roll sheet. Then, an association relationship between the film roll number of the target film roll sheet and the film roll number of the new film roll sheet can be established, thereby establishing an association relationship between the target film roll sheet and the new film roll sheet.

Through the above processing mode, film roll sheets generated during the coating process on each coating surface of the substrate can be associated, thereby achieving the association of production process information, and ensuring quick and accurate traceability of film rolls during battery production.

A method for generating film roll sheets is illustrated with a specific example below. In the specific example, the statistical process control system is an SPC system, the manufacturing execution system may be an MES, and the controller of the coating machine may be a PLC of the coating machine. The specific example specifically includes the following steps:

### Mode 1: Normal Mode.

After a trigger operation for a “Film Roll Mode Selection” button in the function setting page shown in FIG. 5 is detected, the mode selection page shown in FIG. 4 can be displayed in the home page, thereby acquiring the parameter processing mode of the film roll parameters through the mode selection page. After a trigger operation for a “Normal Mode” button in FIG. 4 is detected, the parameter processing mode of the film roll parameters is determined to be the normal mode.

After a trigger operation for a “Create New Film roll” button in FIG. 6 is detected, the first page shown in FIG. 7 is displayed, wherein the first page contains parameter editing areas of film roll numbers and substrate weight. The parameter content of the film roll parameters is determined based on the detected parameter editing areas, and a new film roll sheet is generated after a trigger operation for an “OK” button in FIG. 7 is detected.

### Mode 2: Manual Mode.

After a trigger operation for a “Film Roll Mode Selection” button in the function setting page shown in FIG. 5 is detected, the mode selection page shown in FIG. 4 can be displayed in the home page, thereby acquiring the parameter processing mode of the film roll parameters through the mode selection page. After a trigger operation for a “Manual Mode” button in FIG. 4 is detected, the parameter processing mode of the film roll parameters is determined to be the manual mode.

After a trigger operation for a “Create New Film roll” button in FIG. 6 is detected, the first page shown in FIG. 8 is displayed, wherein the first page contains parameter editing areas of film roll numbers and substrate weight. The parameter content of the film roll parameters is determined based on the detected parameter editing areas. After a trigger operation for a “Check Film Roll Number” button in the first page is detected, it is determined that a parameter check event is detected. At this time, validity check can be performed on the parameter content inputted by a user, thereby obtaining a check result. In a case that the MES successfully checks the parameter content to be checked, after a trigger operation for an “OK” button in FIG. 8 is detected, a new film roll sheet can be generated based on the parameter content of the film roll parameters.

### Mode 3: Automatic Mode.

After a trigger operation for a “Film Roll Mode Selection” button in the function setting page shown in FIG. 5 is detected, the mode selection page shown in FIG. 4 can be displayed in the home page, thereby acquiring the parameter processing mode of the film roll parameters through the mode selection page. After a trigger operation for an “Automatic Mode” button in FIG. 4 is detected, the parameter processing mode of the film roll parameters is determined to be the automatic mode.

After a trigger operation for a “Create New Film roll” button in FIG. 6 is detected, the first page shown in FIG. 9 is displayed, wherein the first page contains a parameter display area of film roll parameters and an acquisition identifier “Acquire Film Roll Number” of film roll parameters.

In a case that an “Acquire Film Roll Number” button in FIG. 9 is detected, it is determined that a trigger event for the acquisition identifier is detected. Then, an acquisition request for film roll numbers can be sent to the film roll management system, such as the MES. After the MES acquires the acquisition request, a new film roll number can be generated, and the new film roll number can be sent to the SPC system. After the SPC system acquires the new film roll number, the new film roll number can be displayed in the parameter display area.

As shown in FIG. 9, the first page also contains a manually inputted parameter “substrate weight”. At this time, the parameter editing area for the substrate weight can be displayed in the first page, and thus, the weight content (i.e., parameter content) of the substrate weight can be determined based on the edited content in the parameter editing area.

A roll change signal of the coating machine is detected according to a preset time interval in the case of determining that a target detection identifier “cutter interaction signal” indicates that the detection is enabled, wherein the target detection identifier is used to indicate whether to perform detection of the roll change signal; and the new film roll sheet is generated based on the parameter content in the case of detecting the roll change signal. In this embodiment of the present application, a new film roll sheet can be generated based on the parameter content in the case of detecting that the target detection identifier indicates that the detection is disabled, and detecting a trigger event for an “OK” button in FIG. 9.

### Mode 4: Fully-Automatic Mode.

After a trigger operation for a “Film Roll Mode Selection” button in the function setting page shown in FIG. 5 is detected, the mode selection page shown in FIG. 4 can be displayed in the home page, thereby acquiring the parameter processing mode of the film roll parameters through the mode selection page. After a trigger operation for a “Fully-Automatic Mode” button in FIG. 4 is detected, the parameter processing mode of the film roll parameters is determined to be the fully-automatic mode.

In this embodiment of the present application, when the parameter processing mode is a “Fully-Automatic Mode”, the roll change signal of the coating machine can be detected, and the parameter content of the film roll parameters is acquired from the target management system in the case of detecting the roll change signal.

Here, the “Fully Automatic Mode” refers to automatic acquisition of film roll parameters, thereby achieving automatic creation and completion of film roll sheets, and disallowing modification of the parameter content of the film roll parameters.

From the above description, it can be seen that when the PLC of the coating machine detects that the diameter of the film roll wound by the winding apparatus of the coating machine reaches a set value (such as 1.2 m), a roll change signal is generated, and the roll change signal is written into a register.

The SPC system can detect the roll change signal in the register according to the preset time interval, and send an acquisition request to the film roll management system (MES) in the case of detecting the roll change signal. After receiving the acquisition request, the MES can generate the parameter content of the film roll parameters and feed the parameter content back to the SPC system; and then, the SPC system can generate a new film roll sheet based on the parameter content. At this time, the MES is a target management system. The substrate weight and the variety name of the film roll can be automatically acquired from an operation sheet management setting module of the SPC. For example, the variety name can be determined according to the film roll sheet attributes set in the operation sheet management setting module.

As shown in FIG. 12, some embodiments of the present application provide a system for generating film roll sheets. The system includes a control system 11 of a coating machine, a statistical process control system 12, and a manufacturing execution system 13. The working process of the above system will be introduced below with reference to the above modes 1 to 4:

### Mode 1:

After detecting a trigger operation for a “Film Roll Mode Selection” button in the function setting page, the statistical process control system controls the display of the mode selection page shown in FIG. 4, thereby acquiring the parameter processing mode of the film roll parameters through the mode selection page. After the statistical process control system detects a trigger operation for a “Normal Mode” button in FIG. 4, the parameter processing mode of the film roll parameters is determined to be the normal mode.

Then, after the statistical process control system detects a trigger operation for a “Create New Film roll” button in FIG. 6, the display of the first page shown in FIG. 7 is controlled, wherein the first page contains parameter editing areas of film roll numbers and substrate weight. Then, the statistical process control system detects the edited content in the parameter editing area, and then determines the parameter content of the film roll parameters according to the edited content. After the statistical process control system detects a trigger operation for an “OK” button in FIG. 7, a new film roll sheet is generated.

### Mode 2:

After detecting a trigger operation for a “Film Roll Mode Selection” button in the function setting page, the statistical process control system controls the display of the mode selection page shown in FIG. 4, thereby acquiring the parameter processing mode of the film roll parameters through the mode selection page. After the statistical process control system detects a trigger operation for a “Manual Mode” button in FIG. 4, the parameter processing mode of the film roll parameters is determined to be the manual mode.

Then, after the statistical process control system detects a trigger operation for a “Create New Film roll” button in FIG. 6, the display of the first page shown in FIG. 8 is controlled, wherein the first page contains parameter editing areas of film roll numbers and substrate weight. The parameter content of the film roll parameters is determined based on the detected parameter editing areas.

Then, after the statistical process control system detects a trigger operation for a “Check Film Roll Number” button in the first page, it is determined that a parameter check event is detected. At this time, the statistical process control system can send a check request to the manufacturing execution system to perform validity check on the parameter content inputted by a user, thereby obtaining a check result. After obtaining the check result, the manufacturing execution system can feed the check result back to the statistical process control system. After the statistical process control system successfully checks the parameter content to be checked based on the check result, a trigger operation for an “OK” button in FIG. 8 is detected, and a new film roll sheet can be generated based on the parameter content of the film roll parameters after the trigger operation is detected.

### Mode 3:

After detecting a trigger operation for a “Film Roll Mode Selection” button in the function setting page, the statistical process control system controls the display of the mode selection page shown in FIG. 4, thereby acquiring the parameter processing mode of the film roll parameters through the mode selection page. After the statistical process control system detects a trigger operation for an “Automatic Mode” button in FIG. 4, the parameter processing mode of the film roll parameters is determined to be the automatic mode.

Then, after the statistical process control system detects a trigger operation for a “Create New Film roll” button in FIG. 6, the display of the first page shown in FIG. 9 is controlled, wherein the first page contains a parameter display area of film roll parameters and an acquisition identifier “Acquire Film Roll Number” of film roll parameters.

Then, in a case that the statistical process control system detects an “Acquire Film Roll Number” button in FIG. 9, it is determined that a trigger event for the acquisition identifier is detected. Then, an acquisition request for film roll numbers can be sent to the film roll management system, such as the manufacturing execution system. After the manufacturing execution system acquires the acquisition request, a new film roll number can be generated, and the new film roll number can be sent to the statistical process control system. After the statistical process control system acquires the new film roll number, the new film roll number can be displayed in the parameter display area.

At this time, the statistical process control system also detects the edited content in the parameter editing area, and thus, the weight content (i.e., parameter content) of the substrate weight can be determined according to the edited content.

The statistical process control system detects a roll change signal of the coating machine according to a preset time interval in the case of determining that a target detection identifier “cutter interaction signal” indicates that the detection is enabled, wherein the target detection identifier is used to indicate whether to perform detection of the roll change signal; and the new film roll sheet is generated based on the parameter content in the case of detecting the roll change signal. In this embodiment of the present application, a new film roll sheet can be generated based on the parameter content in the case of detecting that the target detection identifier indicates that the detection is disabled, and detecting a trigger event for an “OK” button in FIG. 9. The roll change signal is generated by the controller in the case of detecting a cutter signal of the coating machine.

### Mode 4:

After detecting a trigger operation for a “Film Roll Mode Selection” button in the function setting page, the statistical process control system controls the display of the mode selection page shown in FIG. 4, thereby acquiring the parameter processing mode of the film roll parameters through the mode selection page. After the statistical process control system detects a trigger operation for a “Fully-Automatic Mode” button in FIG. 4, the parameter processing mode of the film roll parameters is determined to be the fully-automatic mode.

In the mode 4, when the PLC of the coating machine detects that the diameter of the film roll wound by the winding apparatus of the coating machine reaches a set value (such as 1.2 m), a roll change signal is generated, and the roll change signal is written into a register.

The statistical process control system can detect the roll change signal in the register according to the preset time interval, and send an acquisition request to the manufacturing execution system in the case of detecting the roll change signal. After receiving the acquisition request, the manufacturing execution system can generate the parameter content of the film roll parameters and feed the parameter content back to the statistical process control system; and then, the statistical process control system can generate a new film roll sheet based on the parameter content. At this time, the manufacturing execution system is a target management system. The substrate weight and the variety name of the film roll can be automatically acquired from an operation sheet management setting module of the statistical process control system. For example, the variety name can be determined according to the film roll sheet attributes set in the operation sheet management setting module.

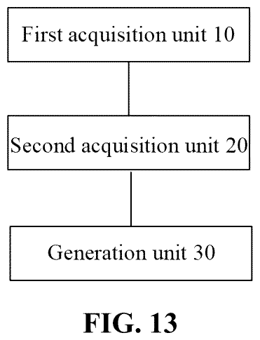

As shown in FIG. 13, some other embodiments of the present application provide an apparatus for generating film roll sheets, configured to perform the method for generating film roll sheets provided in any of the above embodiments. The apparatus includes:
a first acquisition unit 10, configured to acquire a parameter processing mode of film roll parameters, wherein the parameter processing mode is used to indicate a parameter acquisition manner of the film roll parameters in the current operating state of a coating machine;
a second acquisition unit 20, configured to acquire the parameter content of the film roll parameters according to the parameter acquisition manner indicated by the parameter processing mode; and
a generation unit 30, configured to generate a new film roll sheet based on the parameter content, wherein the new film roll sheet is used to record coating process parameters of a substrate.

The second acquisition unit 20 is configured to display a first page corresponding to the parameter processing mode based on a detected film roll sheet creation request, wherein the parameter acquisition manner indicated by the parameter processing mode includes acquisition through the first page; and acquire the parameter content of the film roll parameters through the first page.

The second acquisition unit 20 is configured to display a parameter editing area of the film roll parameters through the first page; and determine the parameter content of the film roll parameters in response to the edited content in the parameter editing area.

The generation unit 30 is configured to perform validity check on the parameter content in the case of detecting a parameter check event to obtain a check result; and generate the new film roll sheet based on the parameter content in the case of determining that the check result is successful.

The generation unit 30 is configured to perform check on the content length of the parameter content to obtain a first sub-check result; perform check on various components of the parameter content to obtain a second sub-check result; and obtain the check result based on the first sub-check result and the second sub-check result.

The apparatus is further configured to: control a check display identifier in the first page to be switched from a first display state to a second display state in the case of determining that the check result is successful, wherein the second display state is used to indicate that the check result is successful.

The second acquisition unit 20 is configured to display a parameter display area of the film roll parameters and an acquisition identifier of the film roll parameters through the first page; send an acquisition request to a film roll management system in the case of detecting a trigger event for the acquisition identifier; and acquire the parameter content returned by the film roll management system based on the acquisition request, and display the parameter content in the parameter display area.

The generation unit 30 is configured to detect a roll change signal of the coating machine according to a preset time interval in the case of determining that a target detection identifier indicates that the detection is enabled, wherein the target detection identifier is used to indicate whether to perform detection of the roll change signal; and generate the new film roll sheet based on the parameter content in the case of detecting the roll change signal.

The second acquisition unit 20 is configured to acquire the parameter content of the film roll parameters from a target management system in the case of detecting the roll change signal of the coating machine.

The apparatus is further configured to: determine and display a second page based on a detected parameter viewing request, and display the parameter display area of the film roll parameters in the second page.

The apparatus is further configured to: stop entering coating process parameters into the current film roll sheet in the case of detecting that the current film roll sheet is completed, store the current film roll sheet into a target storage space, and perform an operation of generating a new film roll sheet based on the parameter content.

The apparatus is further configured to: display a third page based on a detected input request of film roll sheet attributes, wherein the third page contains an attribute editing area; and determine film roll sheet attributes of the new film roll sheet based on the edited content in the attribute editing area.

The apparatus is further configured to: acquire a target film roll sheet of the coated surface in the case of determining that a substrate to be coated contains a coated surface based on the film roll sheet attributes; and establish an association relationship between the target film roll sheet and the new film roll sheet.

The above description of the embodiments tends to emphasize the differences between the embodiments, and the same or similar aspects thereof can be referenced to each other. For the sake of simplicity, the same or similar aspects will not be repeated here.

Electrode plates may be represented in the form of film rolls during the preparation process. Each film roll has a unique corresponding film roll sheet, and the film roll sheet records the substrate parameters of the film roll. The substrate parameters can represent parameters such as the size and weight of the electrode plate, the weight of the coating, and the viscosity of the slurry.

In related technologies, the substrate parameters detected by the collection device are stored in the film roll sheet in real time. That is, after the collection device detects the substrate parameters, the substrate parameters are immediately stored into the film roll sheet. However, because the detection position of the collection device is different from the winding position of the electrode plate, after the electrode plate is detected by the collection device, the electrode plate usually takes a period of time before being transmitted from the collection device to the winding apparatus and wound by the winding apparatus. Therefore, it is possible that the substrate parameters of the electrode plate are stored into the film roll sheet corresponding to the current film roll, but when the cutter apparatus at the winding apparatus is activated to realize the roll change, the electrode plate is not wound to the current film roll by the winding apparatus, which results in the problem of inconsistent substrate parameters between the film roll and the film roll sheet.

To reduce discrepancies between the film roll and the film roll sheet during the coating and winding process, some embodiments of the present application also provide a coating method in which the control apparatus of the coating system predicts the winding time of the substrate and stores the substrate parameters into the film roll sheet corresponding to the substrate at the winding time. Since the substrate parameters of the substrate are stored based on the winding time of the substrate, the situation of discrepancies between the film roll sheet and the film roll caused by storing the substrate parameters of the substrate before the substrate is wound by the coating and winding apparatus can be greatly reduced.

The film roll sheet corresponding to the substrate is generated by the method for generating film roll sheets provided in any of the above embodiments.

It should be understood that the coating methods disclosed in the embodiments of the present application include, but are not limited to, coating processes applied to substrates that can be coated, such as current collectors, paper, cloth, and plastic films.

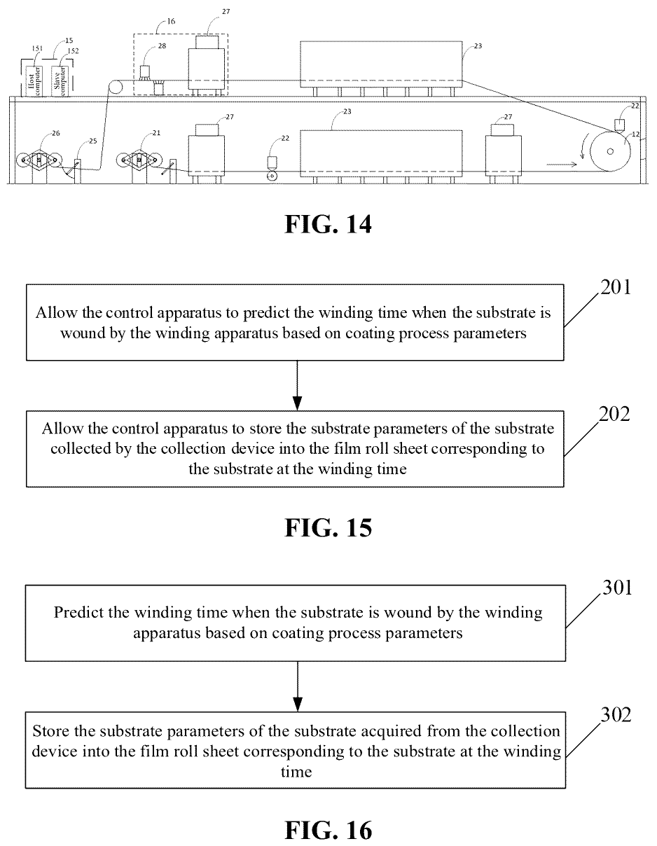

As shown in FIG. 14, some embodiments of the present application further provide a coating system. The coating system may include: an unwinding apparatus 21, a driving apparatus 12, a collection device 16, a winding apparatus 26, and a control apparatus 15.

The driving apparatus 12 is configured to drive a substrate unwound by the unwinding apparatus 21 to move towards the winding apparatus 26, and the winding apparatus 26 is configured to wind the substrate.

The collection device 16 is configured to collect substrate parameters of the substrate passing through the collection device 16.

The control apparatus 15 is configured to predict the winding time when the substrate is wound by the winding apparatus 26 based on coating process parameters, and store the substrate parameters acquired from the collection device 16 into the film roll sheet corresponding to the substrate at the winding time, wherein the film roll sheet is generated by the method for generating film roll sheets provided in any of the above embodiments.

In this embodiment, the coating process parameters are parameters that can represent the transmission duration required for the substrate to be transmitted from the collection device 16 to the winding apparatus 26. In application, the coating process parameters include, but are not limited to, relevant data in the drawings of the coating system and historical operating data of the coating system. The relevant data in the drawings of the coating system may include the distance between the winding apparatus 26 and the collection device 16, and the historical operating data of the coating system may represent the duration required for the substrate to be transmitted from the collection device 16 to the winding apparatus 26.

In this embodiment, the winding time of the substrate includes, but is not limited to, the time when the substrate is wound by the roll drum in the winding apparatus of the coating machine, or the time when the substrate is completely wrapped by the roll drum.

In this embodiment, the collection device 16 includes, but is not limited to, a surface density meter 27, a dimension measurement system 28, etc. The surface density meter 27 and the dimension measurement system 28 are schematically shown in FIG. 14. It should be understood that the coating system may be provided with a plurality of collection devices 16, and the plurality of collection devices 16 may be of the same type or different types. For example, a plurality of collection devices 16 may all be surface density meters 27, or a plurality of collection devices 16 may include both surface density meters 27 and dimension measurement systems 28.

In the solution provided in this embodiment, since the substrate parameters of the substrate are stored based on the winding time of the substrate, the situation of discrepancies between the film roll sheet and the film roll caused by storing the substrate parameters of the substrate before the substrate is wound by the coating and winding apparatus 26 can be greatly reduced.

In one or more embodiments of the present application, as shown in FIG. 14, the control apparatus 15 includes: a host computer 151 and a slave computer 152.

The slave computer 152 is configured to acquire driving parameters of the driving apparatus 12 and transmit the driving parameters to the host computer 151.

The host computer 151 is configured to acquire the substrate parameters from the collection device 16, predict the winding time when the substrate is wound by the winding apparatus 26 based on the driving parameters and pre-configured distance parameters, and store the substrate parameters into the film roll sheet corresponding to the substrate at the winding time, wherein the distance parameters are used to indicate the transmission distance between the collection device 16 and the winding apparatus 26.

In this embodiment, the driving apparatus 12 includes, but is not limited to, a motor, a back roller, etc., and the driving parameters include, but are not limited to, parameters such as rotational speed and power.

In this embodiment, the slave computer 152 and the host computer 151 may communicate with each other in a wired or wireless manner.

In the solution provided in this embodiment, the control apparatus 15 in the coating system is jointly implemented by the host computer 151 and the slave computer 152, and the host computer 151 and the slave computer 152 respectively interact with different devices in the coating system, which helps to improve the reliability of the control apparatus.

The above description of the embodiments tends to emphasize the differences between the embodiments, and the same or similar aspects thereof can be referenced to each other. For the sake of simplicity, the same or similar aspects will not be repeated here.

In one or more embodiments of the present application, the host computer 151 is configured to:
predict the transmission duration required for the substrate to be transmitted from the collection device 16 to the winding apparatus 26 based on the driving parameters and the distance parameters; and
calculate the winding time based on the transmission duration and the collection time of the substrate parameters collected by the collection device 16.

In this embodiment, the driving parameters can be converted to obtain the driving speed of the driving apparatus 12, and the ratio of the distance represented by the distance parameters to the driving speed can be calculated to obtain the transmission duration required for the substrate to be transmitted from the collection device 16 to the winding apparatus 26.

In one example, taking the rotational speed of the back roller as the driving parameter, a formula for calculating the driving speed may be V=2π*R*n, wherein R is the radius of the back roller, and n is the rotational speed of the back roller. It should be noted that the rotational speed of the back roller here may be the theoretical rotational speed. Of course, in order to improve the accuracy of calculation, the rotational speed of the back roller may also be collected in real time. In practical applications, an encoder may be installed on the back roller to collect the rotational speed of the back roller through the encoder.

It should be understood that the winding time is the sum of the transmission duration and the collection time.

In the solution provided in this embodiment, the transmission duration from the collection device 16 to the winding apparatus 26 is calculated, and then the winding time is calculated, which can improve the accuracy of the determined winding time.

The above description of the embodiments tends to emphasize the differences between the embodiments, and the same or similar aspects thereof can be referenced to each other. For the sake of simplicity, the same or similar aspects will not be repeated here.

In one or more embodiments of the present application, the host computer 151 is configured to:
calculate the target distance of the substrate being transmitted in each rotational speed collection cycle based on rotational speed collection cycles contained in the driving parameters and the rotational speed collected in each rotational speed collection cycle;
calculate the cumulative number of collections based on the target distance and the distance parameters; and
calculate the product of the cumulative number of collections and the rotational speed collection cycle to obtain the transmission duration.

It should be understood that the cumulative number of collections represents the number of target distances required for achieving the distance parameters.

Taking the collection device 16 as the surface density meter 27, assuming that the substrate parameters measured by the surface density meter 27 at the time T1 are recorded in the film roll sheet at the time T2 after a delay of x, and the distance between the surface density meter 27 and the winding apparatus 26 is L1, L1=t*(V1+V2+ . . . . Vm). The distance of movement of the substrate per t time is equal to the coating speed multiplied by time. When the cumulative distance traveled in the mth time is equal to the distance L1, it is considered that the electrode plate at the surface density meter 27 moves to the winding apparatus, and the delay duration is x=t*m, and T2=T1+x.

In this embodiment, in order to meet the requirements of engineering applications, in a case that the calculated cumulative number of collections is not an integer, the cumulative number of collections can be rounded. Specifically, based on the target distance and the distance parameter, the maximum integer number of collections is calculated; the cumulative target distance corresponding to the maximum integer number of collections is less than the distance parameter, and the cumulative target distance is the sum of the target distances; the mapping relationship corresponding to the remaining distance parameter is determined; the remaining distance parameter is the difference between the distance parameter and the cumulative target distance; the mapping relationship is the corresponding relationship between the maximum integer number of collections and the cumulative number of collections; and based on the mapping relationship and the maximum integer number of collections, the cumulative number of collections is determined.

In this embodiment, the mapping relationship can be preset based on the relative magnitude relationship between the standard distance parameter and the remaining distance parameter within a collection cycle.

For example, the mapping relationship may be set as follows:

$$s = \{ \begin{matrix}u + 1 , p \geq \frac{1}{2} A \\ \begin{matrix}u , & p < \frac{1}{2} A\end{matrix}\end{matrix}$$

s is the cumulative number of collections, u is the maximum integer number of collections, p is the remaining transmission distance, and A is the standard transmission distance.

In one example, the distance parameter is 100 m, the standard transmission distance within one collection cycle is 20 m, the target distance of the first collection cycle is 20 m, the target distance of the second collection cycle is 18 m, the target distance of the third collection cycle is 23 m, the target distance of the fourth collection cycle is 17 m, and the target distance of the fifth collection cycle is 21 m. Calculations show that in this example, the maximum integer number of collections is 5, the cumulative target distance is 99 m, and the remaining distance is 1 m. Since 1 m<20/2=10 m, it can be determined that the cumulative number of collections is 5.

In the solution provided in this embodiment, the cumulative collection cycle is calculated according to multiple rotational speed collection cycles and the rotational speed in each collection cycle, and then the transmission duration is calculated. This calculation mode considers the situation where the rotational speed of the driving apparatus 12 is not constant in actual operating conditions. Therefore, this calculation mode is closer to the actual operating conditions of the driving apparatus, thereby improving the accuracy of the finally calculated transmission duration.

The above description of the embodiments tends to emphasize the differences between the embodiments, and the same or similar aspects thereof can be referenced to each other. For the sake of simplicity, the same or similar aspects will not be repeated here.

In one or more embodiments of the present application, as shown in FIG. 14, the coating system further includes:
a cutter apparatus 25, configured to cut off the substrate passing through the cutter apparatus 25 when it is determined that a roll change condition is met currently; and
a control apparatus 15, further configured to control the winding apparatus 26 to be switched to a new roll drum and create a film roll sheet corresponding to the new roll drum.

In this embodiment, a roll change condition can be preset based on a roll diameter threshold or a winding duration threshold. For example, the roll change condition can be set as follows: the roll diameter of the roll drum wound currently is greater than the roll diameter threshold, or the winding duration of the roll drum wound currently is greater than the winding duration threshold.

In the solution provided in this embodiment, the cutter apparatus 25 is used in the coating system to cut off the substrate, which can improve the coating efficiency compared to a manner of manually cutting off the substrate. Furthermore, the control apparatus 15 controls the winding apparatus 26 to be automatically switched to a new roll drum, and creates a film roll sheet corresponding to the new roll drum, thereby sequentially achieving automatic roll change of the winding apparatus, and improving the coating efficiency.

The above description of the embodiments tends to emphasize the differences between the embodiments, and the same or similar aspects thereof can be referenced to each other. For the sake of simplicity, the same or similar aspects will not be repeated here.

In one or more embodiments of the present application, as shown in FIG. 14, the coating system further includes a coating device, and the coating device includes a coating die head 22 and coating ovens 23.

The coating die head 22 is configured to coat the substrate passing through the coating die head 22.

The coating oven 23 is configured to bake the substrate coated by the coating die head 22.

In the solution provided in this embodiment, the coating system includes the coating die head 22 for coating the substrate and the coating oven 23 for baking the coated substrate. The introduction of coating devices such as the coating die head 22 and the coating oven 23 allows the collection device 16 to collect more substrate parameters, which helps to understand the coating performance of the coating system.

The above description of the embodiments tends to emphasize the differences between the embodiments, and the same or similar aspects thereof can be referenced to each other. For the sake of simplicity, the same or similar aspects will not be repeated here.

As shown in FIG. 15, an embodiment of the present application further provides a coating method. The method may be applied to the above coating system. The method may include the following steps.

An embodiment of the present application further provides a coating method. The method may be applied to the above coating system. As shown in FIG. 2, the method may include the following steps:
Step 201: The control apparatus is allowed to predict the winding time when the substrate is wound by the winding apparatus based on coating process parameters.
Step 202: The control apparatus is allowed to store the substrate parameters of the substrate collected by the collection device into the film roll sheet corresponding to the substrate at the winding time.

The film roll sheet corresponding to the substrate may be generated by the method for generating film roll sheets provided in any of the above embodiments.

In the solution provided in this embodiment, since the substrate parameters of the substrate are stored based on the winding time of the substrate, the situation of discrepancies between the film roll sheet and the film roll caused by storing the substrate parameters of the substrate before the substrate is wound by the coating and winding apparatus can be greatly reduced.

In some embodiments, the control apparatus includes a host computer and a slave computer. The allowing the control apparatus to predict the winding time when the substrate is wound by the winding apparatus based on coating process parameters includes:
the slave computer is allowed to acquire driving parameters of the driving apparatus and transmit the driving parameters to the host computer; and
the host computer is allowed to acquire the substrate parameters collected by the collection device, predict the winding time when the substrate is wound by the winding apparatus based on the driving parameters and pre-configured distance parameters, and store the substrate parameters into the film roll sheet corresponding to the substrate at the winding time, wherein the distance parameters are used to indicate the transmission distance between the collection device and the winding apparatus.

In the solution provided in this embodiment, the host computer and the slave computer respectively interact with different devices in the coating system to determine the winding time when the substrate is wound by the winding apparatus, which helps to improve the reliability of the control apparatus.

In some embodiments, the allowing the host computer to acquire the substrate parameters collected by the collection device and predict the winding time when the substrate is wound by the winding apparatus based on the driving parameters and pre-configured distance parameters includes:
the host computer is allowed to predict the transmission duration required for the substrate to be transmitted from the collection device to the winding apparatus based on the driving parameters and the distance parameters; and
the host computer is allowed to calculate the winding time based on the transmission duration and the collection time of the substrate parameters collected by the collection device.

In the solution provided in this embodiment, the transmission duration from the collection device to the winding apparatus is calculated, and then the winding time is calculated, which can improve the accuracy of the determined winding time.

In some embodiments, the allowing the host computer to predict the transmission duration required for the substrate to be transmitted from the collection device to the winding apparatus based on the driving parameters and the distance parameters includes:
the target distance of the substrate being transmitted in each rotational speed collection cycle is calculated based on rotational speed collection cycles contained in the driving parameters and the rotational speed collected in each rotational speed collection cycle;
the cumulative number of collections is calculated based on the target distance and the distance parameters; and
the product of the cumulative number of collections and the rotational speed collection cycle is calculated to obtain the transmission duration.

In the solution provided in this embodiment, the cumulative collection cycle is calculated according to multiple rotational speed collection cycles and the rotational speed in each collection cycle, and then the transmission duration is calculated. This calculation mode considers the situation where the rotational speed of the driving apparatus is not constant in actual operating conditions. Therefore, this calculation mode is closer to the actual operating conditions of the driving apparatus, thereby improving the accuracy of the finally calculated transmission duration.

The above description of the embodiments tends to emphasize the differences between the embodiments, and the same or similar aspects thereof can be referenced to each other. For the sake of simplicity, the same or similar aspects will not be repeated here.

It should be understood that the coating method in the embodiments of the present application and the above coating system belong to the same inventive concept, and therefore, the implementation details of the coating method and the coating system can be referenced to each other.

Some embodiments of the present application further provide a coating method. As shown in FIG. 16, the method may be applied to a control apparatus in a coating system. The coating method may include the following steps:
Step 301: The winding time when the substrate is wound by the winding apparatus is predicted based on coating process parameters.
Step 302: The substrate parameters of the substrate acquired from the collection device are stored into the film roll sheet corresponding to the substrate at the winding time.

The film roll sheet corresponding to the substrate may be generated by the method for generating film roll sheets provided in any of the above embodiments.

In some embodiments, the predicting the winding time when the substrate is wound by the winding apparatus based on coating process parameters includes:
the transmission duration required for the substrate to be transmitted from the collection device to the winding apparatus is predicted based on the driving parameters acquired from the driving apparatus and pre-configured distance parameters, the distance parameters being used to indicate the distance between the collection device and the winding apparatus; and
the winding time is calculated based on the transmission duration and the collection time of the substrate parameters acquired from the collection device.

In some embodiments, the predicting the transmission duration required for the substrate to be transmitted from the collection device to the winding apparatus based on the driving parameters acquired from the driving apparatus and pre-configured distance parameters includes:
the target distance of the substrate being transmitted in each rotational speed collection cycle is calculated based on rotational speed collection cycles contained in the driving parameters and the rotational speed collected in each rotational speed collection cycle;
the cumulative number of collections is calculated based on the target distance and the distance parameters; and
the product of the cumulative number of collections and the rotational speed collection cycle is calculated to obtain the transmission duration.

The coating method provided in the above embodiment of the present application and the coating method and coating system provided above have the same inventive concept, and have the same beneficial effects as the method used, operated, or implemented by the stored application program.

By calculating the target distance of the substrate being transmitted within each sampling cycle and then combining the target distance and the transmission distance to calculate the cumulative number of collections, the accuracy of the cumulative number of collections is improved.

According to some embodiments of the present application, optionally, in order to improve the consistency between the storage time of the substrate parameters in the film roll sheet and the winding time of the substrate, after the collection device detects the substrate parameters of the substrate, the substrate parameters can be first stored through a storage device, and then, the substrate parameters are read from the storage device and written into the film roll sheet after the winding time arrives. Storage devices include, but are not limited to, disks and caches.

Specifically, the storing the substrate parameters of the substrate into the film roll sheet corresponding to the substrate at the winding time includes: the substrate parameters are read from the storage device at the winding time; and the substrate parameters are written into the film roll sheet.

By temporarily storing the substrate parameters through the storage device, a foundation for storing the substrate parameters into the film roll sheet is laid for the subsequent winding time.

The above description of the embodiments tends to emphasize the differences between the embodiments, and the same or similar aspects thereof can be referenced to each other. For the sake of simplicity, the same or similar aspects will not be repeated here.

The coating method in the embodiments of the present application is described below using the coating system shown in FIG. 14 as an example. In FIG. 14, starting from the unwinding apparatus 11, the collection device 16 disposed between the unwinding apparatus 11 and the coating die head 17 is labeled as a surface density meter 1, the collection device 16 adjacent to the surface density meter 1 is labeled as a surface density meter 2, the collection device 16 adjacent to the surface density meter 2 is labeled as a surface density meter 3, the collection device 16 adjacent to the surface density meter 2 is labeled as a CCD measurement system 1, and the collection device 16 adjacent to the CCD measurement system 1 is labeled as a CCD measurement system 2.

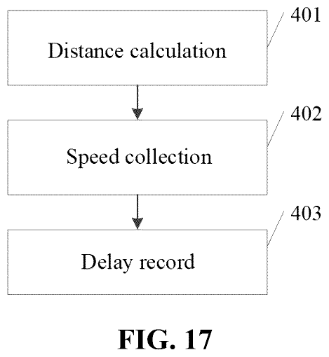

As shown in FIG. 17, the method may include the following steps:
Step 401: The distance is calculated.

The distance difference between the surface density meter 1 and the winding apparatus is L1. L1 is the length of the substrate between the start point and the end point, with the substrate at the surface density meter 1 as a start point and the substrate at the winding apparatus as an end point. During acquisition of L1, the substrate of the start point and the substrate of the end point can be scribed and wound, then the substrate is taken out, and the length of the substrate between the two scribed lines is measured to obtain L1.

The distance difference between the surface density meter 2 and the winding apparatus is L2. L2 is the length of the substrate between the start point and the end point, with the substrate at the surface density meter 2 as a start point and the substrate at the winding apparatus as an end point. During acquisition of L2, the substrate of the start point and the substrate of the end point can be scribed and wound, then the substrate is taken out, and the length of the substrate between the two scribed lines is measured to obtain L2.

The distance difference between the surface density meter 3 and the winding apparatus is L3. L3 is the length of the substrate between the start point and the end point, with the substrate at the surface density meter 3 as a start point and the substrate at the winding apparatus as an end point. During acquisition of L3, the substrate of the start point and the substrate of the end point can be scribed and wound, then the substrate is taken out, and the length of the substrate between the two scribed lines is measured to obtain L3.

The distance difference between the CCD measurement system 1 and the winding apparatus is L4. L4 is the length of the substrate between the start point and the end point, with the substrate at a measurement start point 4 as a start point and the substrate at the winding apparatus as an end point. The distance difference between the CCD measurement system 2 and the winding apparatus is L5. L5 is the length of the substrate between the start point and the end point, with the substrate at a measurement start point 5 as a start point and the substrate at the winding apparatus as an end point. Similarly, during acquisition of L4 and L5, the substrate of the start point and the substrate of the end point can be scribed and wound, then the substrate is taken out, and the length of the substrate between the two scribed lines is measured to obtain L4 and L5.

Step 502: The speed is collected.

An encoder is installed at a shaft end of the back roller to record the rotational speed n in real time, and the rotational speed is collected once at an interval t. If the radius of the back roller is R, the real-time transmission speed is V=2π*R*n.

Step 503: Delay record is performed.

Taking the substrate parameters at the surface density meter 1 as an example, the data measured by the surface density meter 1 at the time T1 is recorded in the film roll sheet at the time T2 after a delay duration of x.

L1=t*(V1+V2+ . . . . Vm). The distance of movement of the substrate per t time is equal to the transmission speed multiplied by time. When the cumulative distance traveled in the mth time is equal to the distance L1, it is considered that the substrate at the measurement start point 1 moves to the winding apparatus, and the delay duration is x-t*m, T2=T1+x.

Similarly, the calculations are performed at the other four collection devices, and the substrate parameters are stored into the film roll sheet according to the calculation time.

The above description of the embodiments tends to emphasize the differences between the embodiments, and the same or similar aspects thereof can be referenced to each other. For the sake of simplicity, the same or similar aspects will not be repeated here.

Before coating the substrate, a corresponding number can usually be assigned to the substrate. Then, before coating the substrate, the number can be manually inputted into the control system of the coating machine. The control system then sets a film roll sheet for the substrate, and records film roll data during the battery coating process through the film roll sheet. During the coating process of the substrate, an electronic tag can be generated for the substrate by manually inputting a number, and the electronic tag is set on the film roll drum of the coated substrate. The tag content of the electronic tag is recorded as the number of the above substrate.

If the number assigned to the substrate and the tag content of the electronic tag are different, the substrate cannot be accurately traced during the battery production process. When abnormalities occur during the film roll coating process or during the battery production process, it will be impossible to trace and locate the substrate in time.

Based on the above research, an embodiment of the present application discloses a coating system. In the system, the controller generates a roll change signal in the case of detecting that the winding apparatus of the coating machine performs a disconnecting operation and is connected to a target film roll; then, the statistical process control system sends a processing request for film roll numbers to the manufacturing execution system after detecting the roll change signal; the manufacturing execution system determines a first film roll number of the target film roll after receiving the processing request, and sends the first film roll number to the statistical process control system; and the statistical process control system can create a first film roll sheet based on the first film roll number after acquiring the first film roll number, thereby recording the production process information of the target film roll during the coating process through the first film roll sheet.

In this embodiment, the automatic generation of film roll numbers can be achieved through the interactive operation among the controller, the statistical process control system, and the manufacturing execution system. The processing mode does not require the manual input of film roll numbers, and also does not require the creation of a film roll sheet based on manually inputted film roll numbers. By means of automatically acquiring the first film roll number from the manufacturing execution system of the coating machine in response to the roll change signal, the process of acquiring the first film roll number can be automatically completed, thereby improving the degree of automation of the entire process, saving the labor cost, improving the consistency of film roll identifiers set on the first film roll sheet and the film roll, and reducing errors caused by manual operation.

The coating method provided in the embodiments of the present application can be applied to process the film roll sheet of any target film roll. The batteries in the embodiments of the present application may be lithium-ion batteries, lithium metal batteries, etc., such as lithium cobalt oxide batteries, lithium manganate batteries, lithium nickel cobalt manganese oxide batteries, lithium nickel cobalt aluminum oxide batteries, lithium iron phosphate batteries, lithium titanate batteries, and lithium-sulfur batteries. Or, the batteries in the embodiments of the present application may include, but are not limited to, batteries of other material systems, such as lead-acid batteries, nickel-chromium batteries, nickel-hydrogen batteries, or sodium-ion batteries.

For ease of description, the specific processes of the embodiments of the present application will be described in detail below by the involved device, including a statistical process control system, a manufacturing execution system and a controller, as an example.

Referring to FIG. 12, an embodiment of the present application provides a coating system. The coating system includes: a statistical process control system 11, a manufacturing execution system 12, and a controller 13 of a coating machine.

The controller 13 is configured to generate a roll change signal in the case of detecting that a winding apparatus of the coating machine performs a disconnecting operation and is connected to a target film roll.

The statistical process control system 11 is configured to send a processing request for film roll numbers to the manufacturing execution system in response to the roll change signal, acquire a first film roll number of a target film roll sent by the manufacturing execution system based on the processing request, and create a first film roll sheet based on the first film roll number, wherein the first film roll sheet is used to record the production process information of the target film roll during the coating process.

The manufacturing execution system 12 is configured to determine the first film roll number of the target film roll in response to the processing request, and send the first film roll number to the statistical process control system.

The statistical process control (SPC) system may include, but is not limited to, a device that performs statistical analysis and evaluation of the production process of the coating machine, and the manufacturing execution system may include, but is not limited to, a device that maintains the film roll number and film roll sheet of the coating machine. Here, the statistical process control system and the manufacturing execution system may be different system modules in the same device; or, the statistical process control system and the manufacturing execution system may be different system modules in different devices. The connection relationship between the statistical process control system and the manufacturing execution system may be wired connection, wireless connection, or the like.

As shown in FIG. 12, the manufacturing execution system 12 and the controller 13 of the coating machine are respectively in communication with the statistical process control system 11. Each coating machine may be correspondingly provided with a statistical process control system 11 and a controller 13 of the coating machine, and each manufacturing execution system 12 may be in communication with a plurality of statistical process control systems 11.

In this embodiment of the present application, the coating machine includes a controller, an unwinding apparatus, a coating die head, a coating oven, a winding apparatus, and the like. The controller includes, but is not limited to, a programmable logic controller (PLC).

Here, the coating machine may be a single-layer coating machine or a double-layer coating machine. FIG. 2 is a schematic structural diagram of a single-layer coating machine. FIG. 3 is a schematic structural diagram of a double-layer coating machine.

As shown in FIG. 2 and FIG. 3, a substrate can be placed on the unwinding apparatus 21, and after automatic correction, the substrate enters the coating die head 22. The coating die head 22 can coat the substrate with coating slurry according to a set program. A wet electrode plate obtained by coating enters the coating oven 23 and is dried with hot air. The tension of the dried electrode plate is adjusted by the tension swing roller 24, while the winding speed of the winding apparatus 26 is controlled to synchronize the winding speed with the coating speed. The dried electrode plate is automatically corrected by a correction system and kept in a center position, and then wound by the winding apparatus 26. When the coating machine detects that the diameter of the film roll wound by the winding apparatus 26 of the coating machine reaches a set value, the controller 13 of the coating machine generates a roll change signal. At this time, the winding apparatus 26 of the coating machine is automatically disconnected and connected to a new film roll drum.

After the statistical process control system detects the roll change signal of the coating machine, a processing request for film roll numbers can be sent to the manufacturing execution system of the coating machine. The manufacturing execution system determines a first film roll number of the target film roll after receiving the processing request, and sends the first film roll number to the statistical process control system.

In this embodiment of the present application, the film roll number may include, but is not limited to, the following: position information, time information, coating surface information, and indicator, wherein the position information is used to indicate the position of the coating machine; the coating surface information is used to indicate the information of the coating surface of the coating machine; the time information is used to indicate the production date of the coating slurry and the coating date of the substrate; and the indicator is an indicator generated according to the sending order of the processing request. Here, the film roll number is a carrier of film roll related information, and material identification and tracing can be achieved through the film roll number.

Here, the first film roll sheet is used to record the production process information of the target film roll during the coating process. The production process information includes, but is not limited to, information such as production base of the target film roll, workshop, machine, date, formula, time, weight data and real-time dimension data of the substrate during the coating process, and process parameters of the coating machine. Here, the weight data includes the substrate weight before coating, the substrate weight after the first surface of the substrate is coated, and the substrate weight after the first and second surfaces of the substrate are coated.

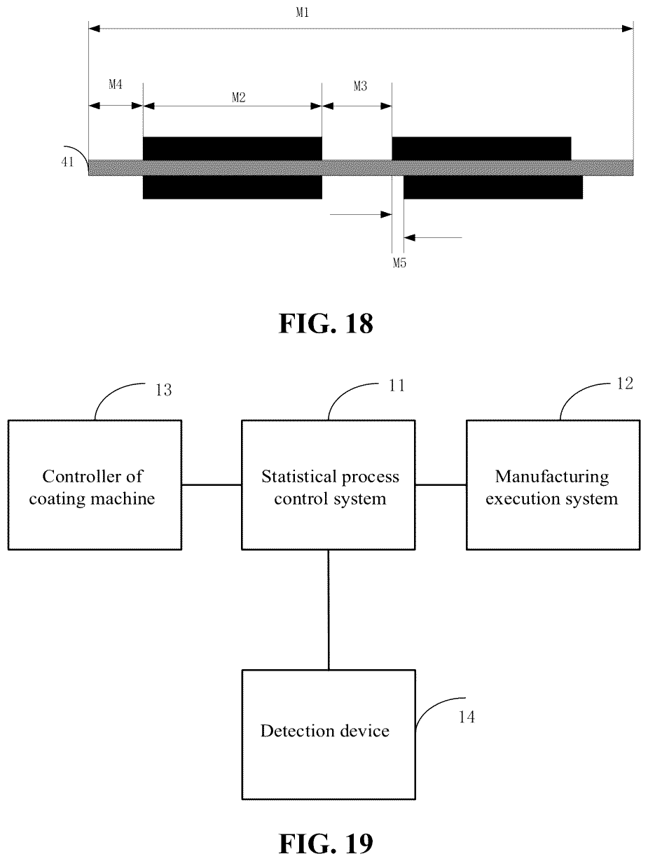

In this embodiment of the present application, the substrate weight can be determined by measuring the density data of the substrate. Here, the density data includes surface density of the substrate, surface density of the first surface, and surface density of the first surface and the second surface, wherein the surface density of the substrate is used to indicate the surface density of the uncoated substrate in the target film roll, the surface density of the first surface is used to indicate the surface density after one surface of the substrate is coated, and the surface density of the first surface and the second surface is used to indicate the surface density after two surfaces of the substrate are coated. As shown in FIG. 18, the real-time dimension data includes a total width M1 of a substrate 41, a width M2 of a coating area, a width M3 of a coating interval, a width M4 of a blank area, and a misalignment width M5 between the coating areas of a first surface 42 and a second surface 43.

In these embodiments, the statistical process control system of the coating machine can detect a roll change signal of the coating machine and send a processing request for film roll numbers to the manufacturing execution system of the coating machine after detecting the roll change signal; the manufacturing execution system determines a first film roll number for the target film roll in response to the processing request, and sends the first film roll number to the statistical process control system; and the statistical process control system acquires the first film roll number of the target film roll sent by the manufacturing execution system based on the processing request, and creates a first film roll sheet based on the first film roll number, thereby recording the production process information of the target film roll during the coating process through the first film roll sheet. Through the processing mode, the process of acquiring the first film roll number can be automatically completed, and the process of creating the first film roll sheet can be automatically completed, thereby improving the degree of automation of the entire process, saving the labor cost, also improving the consistency between the first film roll sheet and the roll stock, and reducing the errors caused by manual operation.

In some embodiments of the present application, the coating system further includes: a first register.

The first register is configured to store the roll change signal, wherein the storage address of the first register is a first storage address.

The statistical process control system is configured to read first storage data in the first register, and determine that the roll change signal is detected in the case of determining that the first storage data is first data, wherein the first data is used to represent that the winding apparatus of the coating machine is connected to the target film roll.

In the embodiments of the present application, the first register for storing roll change signals can be provided in advance, wherein the address of the first register is the above first storage address.

The statistical process control system of the coating machine can read the data in the first storage address as the first storage data; and then, the statistical process control system can determine whether a roll change signal is detected based on the read first storage data. At this time, whether the first storage data is the first data can be determined. If it is determined that the first storage data is the first data, it can be determined that the roll change signal is detected.

Here, the first data is used to represent that the winding apparatus of the coating machine is connected to the target film roll, wherein the target film roll may be the new film roll described above. That is, after the controller of the coating machine detects the automatic disconnecting operation of the cutter apparatus, the roll change signal written into the first storage address is the first data. For example, the first data may be “1”, “01”, “001”, or other data.

In the above embodiment, the controller of the coating machine writes the roll change signal into the first storage address, and the statistical process control system can automatically acquire the roll change signal from the first storage address and automatically send a processing request for film roll numbers to the manufacturing execution system, thereby automatically completing the process of acquiring the first film roll number, and improving the degree of automation of the entire process. By setting the statistical process control system to automatically read the first storage data from the first storage address, the creation time of the film roll sheet can be shortened, coating process scenes with relatively high real-time requirements can be met, and the consistency between the production process information in the film roll sheet and the film roll can be improved.

In some embodiments of the present application, the coating system further includes: a cutter apparatus; and
a controller, configured to generate a roll change signal after detecting the automatic disconnecting operation of the cutter apparatus, and write the roll change signal into the first register.

In this embodiment of the present application, in a case that the diameter of the film roll wound by the winding apparatus of the coating machine is detected to reach a set value, the winding apparatus of the coating machine is automatically disconnected and connected to a new film roll through the cutter apparatus. After the controller of the coating machine detects the automatic disconnecting operation of the cutter apparatus, a roll change signal is generated, and the roll change signal is written into the first storage address. For example, a roll change signal “1” can be generated, and the roll change signal “1” is written into the first storage address.

Through the above processing mode, automatic generation of the roll change signal can be achieved, and the roll change signal is automatically stored to enable the statistical process control system to successfully acquire the roll change signal, so that the creation time of the film roll sheet can be shortened, coating process scenes with relatively high real-time requirements can be met, and the consistency between the production process information in the film roll sheet and the film roll can be improved.

In some embodiments of the present application, the statistical process control system is configured to:
read the first storage data in the first storage address according to a preset time interval, wherein the storage duration of the first storage data in the first storage address is greater than the preset time interval.

In this embodiment of the present application, in a case that the diameter of the film roll wound by the winding apparatus of the coating machine is detected to reach a set value, the winding apparatus of the coating machine is automatically disconnected and connected to a target film roll through the cutter apparatus. After the controller of the coating machine detects the automatic disconnecting operation of the cutter apparatus, a roll change signal is generated, and the roll change signal is written into the first storage address. The storage duration of the roll change signal in the first storage address may be set as a target duration, for example, the target duration may be 1 s, 2 s, 3 s, etc. Here, the storage duration of the roll change signal in the first storage address can be determined according to the coating speed and real-time requirements of the coating machine.

In this embodiment of the present application, the statistical process control system can be configured to periodically refresh and read data in the first storage address. When it is determined that the read first storage data is the first data, a processing request for film roll numbers is sent to the manufacturing execution system of the coating machine. Here, the statistical process control system can be configured to read the first storage data in the first storage address according to a preset time interval.

In order to enable the statistical process control system to quickly and accurately read the roll change signal from the first storage address, the storage duration of the roll change signal in the first storage address can be set to be greater than the preset time interval. For example, if the storage duration is 1 s, the preset time interval can be less than 1 s, such as 0.8 s.

Because the statistical process control system periodically refreshes and reads data in the first storage address, by setting the storage duration of the first storage data in the first storage address, the problem of repeatedly sending processing requests to the manufacturing execution system due to the repeated reading of the roll change signal can be alleviated. By setting the preset time interval to be less than the storage duration of the first storage data in the first storage address, the probability of reading the roll change signal from the first storage address can be increased.

In some embodiments of the present application, as shown in FIG. 19, the coating system further includes:
a detection device 14, configured to detect production process information of the target film roll during the coating process; and
a statistical process control system, configured to acquire the production process information of the target film roll returned by the detection device based on a data transmission signal, store the production process information into a target cache space in the case of detecting that the creation of the first film roll sheet is not completed, and store the production process information cached in the target cache space into the first film roll sheet in the case of detecting that the creation of the first film roll sheet is completed.

In this embodiment of the present application, after the detection device acquires the data transmission signal, the production process information that is not transmitted can be fed back to the statistical process control system.

After the statistical process control system acquires the production process information, whether the creation of the first film roll sheet is completed can be detected. If it is detected that the creation is not completed, the production process information can be stored into the target cache space. The target cache space described here may be the same as the cache space described in the above embodiment, or may be a different cache space. If it is detected that the creation is completed, the production process information can be recorded in the first film roll sheet. At the same time, the production process information stored in the target cache space can also be recorded in the first film roll sheet, and the target cache space can be cleared.

In the above embodiment, in the case of detecting that the creation of the first film roll sheet is not completed, more comprehensive production process information can be obtained by caching the production process information in the target cache space, thereby improving the comprehensiveness and reliability of the production process information in the first film roll sheet.

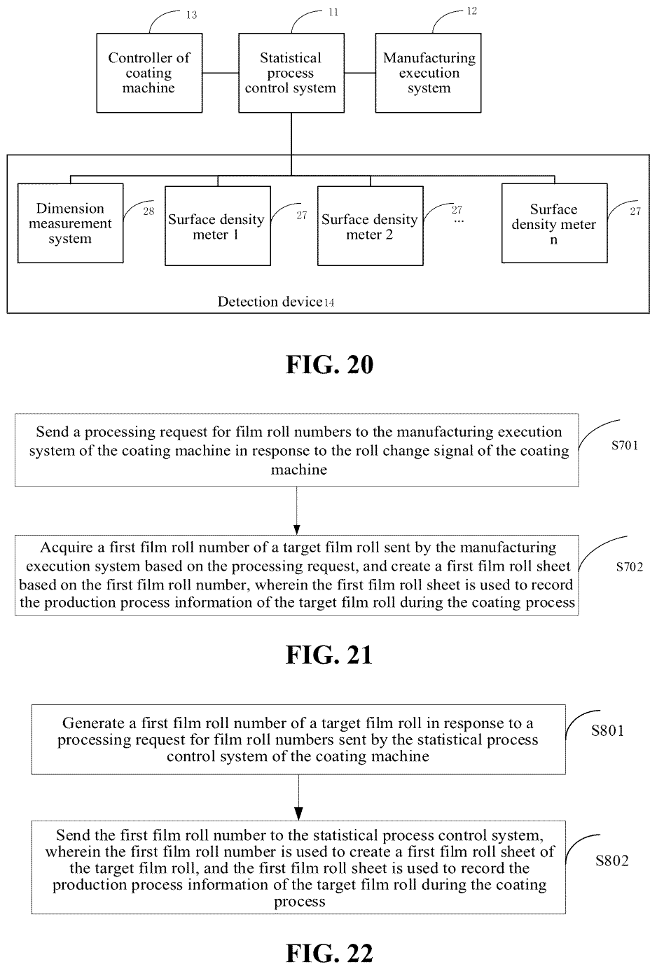

In some embodiments of the present application, as shown in FIG. 20, the detection device 14 includes: a surface density meter 27 and a dimension measurement system 28.

The surface density meter 27 is configured to detect the density data of the substrate during the coating process.

The dimension measurement system 28 is configured to detect real-time dimension data of each coating surface of the substrate during the coating process.

Here, the surface density meter may be an x/β-Ray surface density meter, and the dimension measurement system may be a charge coupled device (CCD) measurement system. The surface density meter and the dimension detection system in the detection device are both connected to the statistical process control system.

As shown in FIG. 20, there may be a plurality of surface density meters. For example, as shown in FIG. 3, three surface density meters 27 are disposed in the double-layer coating machine. The three surface density meters 27 are respectively disposed between the unwinding apparatus 21 and the first-sided coating oven 23, between the first-sided coating oven 23 and the second-sided coating oven 23, and between the second-sided coating oven 23 and the dimension measurement system 28.

Here, the density data includes surface density of the substrate, surface density of the first surface, and surface density of the first surface and the second surface, wherein the surface density of the substrate is used to indicate the surface density of the uncoated substrate in the target film roll, the surface density of the first surface is used to indicate the surface density after one surface of the substrate is coated, and the surface density of the first surface and the second surface is used to indicate the surface density after two surfaces of the substrate are coated. As shown in FIG. 18, the real-time dimension data includes a total width M1 of a substrate 41, a width M2 of a coating area, a width M3 of a coating interval, a width M4 of a blank area, and a misalignment width M5 between the coating areas of a first surface 42 and a second surface 43.

Through the above processing mode, the production process information of the target film roll during the coating process can be acquired in real time, thereby achieving the automatic storage of the production process information, improving the degree of automation of the entire process, saving the labor cost, and reducing errors caused by manual operation.

In some embodiments of the present application, the statistical process control system is configured to:
determine the request number of the first film roll number; and generate a processing request based on the request number.

In this embodiment of the present application, the statistical process control system can determine the request number of the first film roll number, wherein the request number may be an integer greater than or equal to 1. For example, the statistical process control system can request a first film roll number from the manufacturing execution system, or request multiple first film roll numbers from the manufacturing execution system.

Here, the request number of the first film roll number can be determined according to a number threshold preset by a user. Here, the statistical process control system can provide an input interface for the user and receive the number threshold set by the user through the input interface, and then request the first film roll number from the manufacturing execution system according to the number threshold.

If the statistical process control system requests multiple first film roll numbers from the manufacturing execution system, the statistical process control system can use each first film roll number sequentially until all the first film roll numbers are used, and then, first film roll numbers can be requested again from the manufacturing execution system. The process of using multiple first film roll numbers by the statistical process control system can be described as follows:

The statistical process control system creates a first film roll sheet B for a target film roll based on a first film roll number A. If a roll change signal is detected again, whether the multiple first film roll numbers are used completely is viewed. If it is determined that the multiple first film roll numbers are not used completely, a second film roll sheet D is created for the target film roll based on an unused first film roll number C. If it is determined that the multiple first film roll numbers are used completely, a processing request for film roll numbers is sent to the manufacturing execution system of the coating machine.

By setting the request number of the first film roll number, at least one first film roll number can be requested from the manufacturing execution system each time, thereby improving the flexibility of requesting the first film roll number to meet different production needs.

In some embodiments of the present application, the manufacturing execution system is configured to:
parse the processing request to acquire the number of requested film roll numbers, so as to obtain the request number; and generate the request number of the first film roll numbers.

The statistical process control system can determine the request number of the first film roll number according to the number threshold preset by the user, wherein the request number may be an integer greater than or equal to 1. Here, the statistical process control system can provide an input interface for the user and receive the number threshold set by the user through the input interface, and then request the first film roll number from the manufacturing execution system according to the number threshold. Subsequently, the statistical process control system generates a processing request based on the request number, and sends the processing request for film roll numbers to the manufacturing execution system.

After the manufacturing execution system acquires the processing request, each request field in the processing request is parsed, so as to parse the number field for indicating the request number to obtain the request number of the first film roll number. Then, the request number of the first film roll number can be generated.

By setting the request number of the first film roll number, at least one first film roll number can be requested from the manufacturing execution system each time, thereby improving the flexibility of requesting the first film roll number to meet different production needs.

In some embodiments of the present application, the manufacturing execution system is configured to:
determine the attribute information of the coating machine and the coating attributes of the target film roll in the processing request; and
generate the first film roll number of the target film roll based on the attribute information of the coating machine and the coating attributes of the target film roll.

Here, the attribute information of the coating machine includes, but is not limited to, base, workshop, cathode and anode, wherein the base and workshop are used to indicate the base and workshop where the coating machine is located; and the cathode and anode are used to indicate whether the surface coated by the coating machine is a cathode surface or an anode surface. The coating attributes of the target film roll include, but are not limited to, substrate type, slurry date, and roll drum type, wherein the substrate type is used to indicate the type of the substrate to be coated, the slurry date is used to indicate the production date of the coating slurry and the production date of the coating process on the substrate, and the roll drum type is used to indicate the type of a roll drum in which the target film roll is located.

The first film roll number of the target film roll can be generated by determining the attribute information of the coating machine and the coating attributes of the target film roll.

Through the above processing mode, the attribute information of the coating machine and the coating attributes of the target film roll can be more intuitively reflected through the film roll number, thereby accelerating the tracing speed of film rolls, and increasing the success rate of film roll tracing.

In some embodiments of the present application, the statistical process control system is configured to determine a second film roll number in the case of determining that the substrate to be coated contains a coated surface, and send a processing request carrying the second film roll number to the manufacturing execution system, wherein the second film roll number is the film roll number obtained during the coating process of the coated surface, and the substrate to be coated is the substrate that needs to be coated after being connected to the target film roll; and the manufacturing execution system is configured to generate the first film roll number and establish an association relationship between the first film roll number and the second film roll number.

In this embodiment of the present application, the statistical process control system determines a second film roll number in the case of determining that the substrate to be coated contains a coated surface, and sends a processing request carrying the second film roll number to the manufacturing execution system. Here, the process in which the statistical process control system determines whether the substrate to be coated contains a coated surface is the same as the process described in the above embodiments, and will not be described in detail here.

After the manufacturing execution system acquires the processing request, each request field in the processing request can be parsed, so as to parse the number field to obtain the second film roll number and generate the first film roll number; and then, the association relationship between the first film roll number and the second film roll number can be established.

Here, an association relationship table can be preset, and film roll numbers with association relationships can be recorded through the association relationship table. At this time, the first film roll number and the second film roll number can be recorded in the association relationship table to establish the association relationship between the first film roll number and the second film roll number.

Through the above processing mode, film roll sheets generated during the coating process on each coating surface of the substrate can be associated, thereby achieving the association of production process information, and ensuring quick and accurate traceability of film rolls during battery production.

Referring to FIG. 21, an embodiment of the present application provides a coating method. The method is applied to the statistical process control system in the coating system provided in the above embodiments, and specifically includes the following steps:

Step 701: A processing request for film roll numbers is sent to the manufacturing execution system of the coating machine in response to the roll change signal of the coating machine.

In this embodiment of the present application, the coating machine includes a controller of the coating machine, an unwinding apparatus of the coating machine, a coating die head, a coating oven, a winding apparatus of the coating machine, and the like. The controller of the coating machine includes, but is not limited to, a programmable logic controller (PLC).

Here, the coating machine may be a single-layer coating machine or a double-layer coating machine. FIG. 2 is a schematic structural diagram of a single-layer coating machine. FIG. 3 is a schematic structural diagram of a double-layer coating machine.

As shown in FIG. 2, the single-layer coating machine includes an unwinding apparatus of the coating machine, a single-sided coating die head, a coating oven, a tension swing roller, a cutter apparatus, and a winding apparatus of the coating machine. As shown in FIG. 3, the double-layer coating machine includes an unwinding apparatus of the coating machine, double-sided coating dies (i.e., the first-sided coating die and the second-sided coating die in FIG. 3), two coating ovens (i.e., the first-sided coating oven and the second-sided coating oven in FIG. 3), a tension swing roller, a cutter apparatus, and a winding apparatus of the coating machine.

As shown in FIG. 2 and FIG. 3, a substrate can be placed on the unwinding apparatus, and after automatic correction, the substrate enters the coating die head. The coating die head can coat the substrate with coating slurry according to a set program. A wet electrode plate obtained by coating enters the coating oven and is dried with hot air. The tension of the dried electrode plate is adjusted by the tension swing roller, while the winding speed of the winding apparatus is controlled to synchronize the winding speed with the coating speed. The dried electrode plate is automatically corrected by a correction system and kept in a center position, and then wound by the winding apparatus. When the coating machine detects that the diameter of the film roll wound by the winding apparatus of the coating machine reaches a set value, the coating machine generates a roll change signal. At this time, the winding apparatus of the coating machine is automatically disconnected and connected to a new film roll drum.

After the statistical process control system detects the roll change signal of the coating machine, a processing request for film roll numbers can be sent to the manufacturing execution system of the coating machine.

In this embodiment of the present application, the statistical process control system may be a statistical process control (SPC) system, and the manufacturing execution system may be an MES.

Step 702: A first film roll number of a target film roll sent by the manufacturing execution system based on the processing request is acquired, and a first film roll sheet is created based on the first film roll number, wherein the first film roll sheet is used to record the production process information of the target film roll during the coating process.

Here, after the statistical process control system sends a processing request for film roll numbers to the manufacturing execution system, the feedback information from the manufacturing execution system in response to the processing request can be acquired, and the first film roll number determined by the manufacturing execution system for the target film roll can be acquired from the feedback information.

In this embodiment of the present application, the film roll number may include, but is not limited to, the following: position information, time information, coating surface information, and indicator, wherein the position information is used to indicate the position of the coating machine; the coating surface information is used to indicate the information of the coating surface of the coating machine; the time information is used to indicate the production date of the coating slurry and the coating date of the substrate; and the indicator is an indicator generated according to the sending order of the processing request. Here, the film roll number is a carrier of film roll related information, and material identification and tracing can be achieved through the film roll number.

After the statistical process control system acquires the first film roll number, a first film roll sheet can be created based on the first film roll number. Here, a film roll sheet template that matches the coating machine can be acquired from a film roll sheet template library; and the name of the film roll sheet template is determined based on the first film roll number to obtain the first film roll sheet. The name of the first film roll sheet is recorded as the first film roll number.

Here, the first film roll sheet is used to record the production process information of the target film roll during the coating process. The production process information includes, but is not limited to, information such as production base of the target film roll, workshop, machine, date, formula, time, weight data and real-time dimension data of the substrate during the coating process, and process parameters of the coating machine. Here, the weight data includes the substrate weight before coating, the substrate weight after the first surface of the substrate is coated, and the substrate weight after the first and second surfaces of the substrate are coated.

In this embodiment of the present application, the substrate weight can be determined by measuring the density data of the substrate. Here, the density data includes surface density of the substrate, surface density of the first surface, and surface density of the first surface and the second surface, wherein the surface density of the substrate is used to indicate the surface density of the uncoated substrate in the target film roll, the surface density of the first surface is used to indicate the surface density after one surface of the substrate is coated, and the surface density of the first surface and the second surface is used to indicate the surface density after two surfaces of the substrate are coated. As shown in FIG. 18, the real-time dimension data includes a total width of a substrate, a width of a coating area, a width of a coating interval, a width of a blank area, and a misalignment width between the coating areas of a first surface and a second surface.

In the technical solution of this embodiment of the present application, after a roll change signal of the coating machine is detected, a processing request for film roll numbers is sent to the manufacturing execution system of the coating machine; and a first film roll number of a target film roll sent by the manufacturing execution system based on the processing request is acquired, and thus, a first film roll sheet is created based on the first film roll number. The above processing does not require the manual input of film roll numbers, and also does not require the creation of a film roll sheet based on manually inputted film roll numbers. By means of automatically acquiring the first film roll number from the manufacturing execution system of the coating machine in response to the roll change signal, the process of acquiring the first film roll number can be automatically completed, and the process of creating the first film roll sheet can be automatically completed, thereby improving the degree of automation of the entire process, saving the labor cost, also improving the consistency between the first film roll sheet and the roll stock, and reducing the errors caused by manual operation.

In some embodiments of the present application, on the basis of the above embodiment, the technical solution provided in an embodiment of the present application further includes the following step:

data update information is sent to the controller of the coating machine in response to the roll change signal, wherein the data update information is used to indicate that the first data in the first storage address is updated to second data, and the second data is used to indicate that the statistical process control system successfully reads the roll change signal.

In this embodiment of the present application, after the statistical process control system reads the first storage data from the first storage address and determines that the first storage data is the first data, it can be determined that a roll change signal is detected. At this time, the winding apparatus of the coating machine is automatically disconnected and connected to a target film roll, and the coated substrate is wound into the target film roll. Before the diameter of the target film roll reaches the set value, there is no need to perform a roll change operation. At this time, the first data in the first storage address can be updated to the second data, so that the second data indicates that the statistical process control system successfully reads the roll change signal.

Here, after detecting the roll change signal, the statistical process control system can send data update information to the controller of the coating machine, so that the data update information indicates the controller to update the first data in the first storage address to the second data. Here, the first data and the second data may be binary data, octal data, decimal data, or hexadecimal data. For example, if the first data is “1”, the second data can be set to “0”; and if the first data is “A”, the second data can be set to “B”.

After the controller of the coating machine acquires the data update information, the first data in the first storage address can be updated to the second data; and after it is determined that the diameter of the target film roll reaches the set value, the second data in the first storage address can be updated to the first data again, so as to indicate that the winding apparatus of the coating machine is connected to the next film roll drum.

In the above embodiment, by sending the data update information to the controller of the coating machine, the controller is prompted to modify the first data to the second data according to the data update information, which can achieve timely updating of the roll change signal, thereby alleviating the problem of repeatedly sending processing requests to the manufacturing execution system due to repeated reading of the roll change signal.

In some embodiments of the present application, on the basis of the above embodiment, the technical solution provided in an embodiment of the present application further includes the following step:
a data transmission signal carrying the first film roll number is sent to a detection device, wherein the detection device is configured to detect the production process information of the target film roll during the coating process.

In this embodiment of the present application, after the statistical process control system detects the roll change signal, a transmission stop signal can be sent to the detection device, wherein the transmission stop signal is used to indicate that the transmission of the production process information to the statistical process control system should be stopped. In other words, after the roll change signal is detected, the detection device can continue to detect the substrate connected to the target film roll, thereby obtaining production process information.

After the statistical process control system acquires the first film roll number of the target film roll sent by the manufacturing execution system based on the processing request, the data transmission signal carrying the first film roll number can be sent to the detection device. After the detection device acquires the data transmission signal, the production process information that is not transmitted can be transmitted to the statistical process control system for recording. Here, the production process information that is not transmitted can be understood as the production process information obtained by detecting the substrate after the transmission stop signal is received.

After the detection device receives the transmission stop signal, the detected production process information can be stored into a local storage space; and after a data transmission signal is received, the production process information is transmitted to the statistical process control system. If the local storage space of the detection device is full, the detection device can send a transmission request to the statistical process control system, so as to request the transmission of the production process information into the cache space of the statistical process control system.

In this embodiment of the present application, the detection device includes a surface density meter and a dimension detection system, wherein the surface density meter may be an x/β-Ray surface density meter, and the dimension detection system may be a CCD measurement system.

Here, data transmission signals carrying the first film roll number can be sent to the surface density meter and the dimension detection system respectively, wherein the surface density meter is configured to detect the density data of the substrate during the coating process, and the dimension detection system is configured to detect the real-time dimension data of each coating surface of the substrate during the coating process. The density data includes the surface density of the substrate described above, the surface density of the first surface, and the surface density of the first surface and the second surface. The real-time dimension data includes a total width of the substrate described above, a width of a coating area, a width of a coating interval, and a width of a blank area.

In this embodiment of the present application, there may be a plurality of surface density meters. For example, as shown in FIG. 2, two surface density meters and one CCD measurement system are disposed in a single-layer coating machine. The two surface density meters are respectively a surface density meter 1 and a surface density meter 2. The two surface density meters are respectively disposed between the unwinding apparatus and the coating oven, and between the coating oven and the CCD measurement system. As shown in FIG. 3, three surface density meters (a surface density meter 1, a surface density meter 2, and a surface density meter 3) and one CCD measurement system are disposed in a double-layer coating machine. The three surface density meters are respectively disposed between the unwinding apparatus and the first-sided coating oven, between the first-sided coating oven and the second-sided coating oven, and between the second-sided coating oven and the CCD measurement system.

In a case that there are a plurality of surface density meters, data transmission signals can be sent to each of the surface density meters simultaneously. Or, a data transmission signal can be sent to a master controller of a plurality of surface density meters, and the master controller can send the data transmission signal to each surface density meter.

After the data transmission signal is sent to the detection device, the statistical process control system can acquire the detection information returned by the detection device based on the data transmission signal, wherein the detection information includes the production process information of the target film roll during the coating process and the first film roll number. Then, the production process information can be stored in the first film roll sheet based on the first film roll number in the detection information.

In the above embodiment, by means of sending the data transmission signal carrying the first film roll number to the detection device, the production process information transmitted by the detection device can be the production process information of the target film roll corresponding to the first film roll sheet, thereby improving the consistency between the production process information in the first film roll sheet and the target film roll.

In some embodiments of the present application, on the basis of the above embodiment, the technical solution provided in an embodiment of the present application further includes the following steps:
the production process information of the target film roll returned by the detection device based on the data transmission signal is acquired; the production process information is stored into a target cache space in the case of detecting that the creation of the first film roll sheet is not completed; and the production process information cached in the target cache space is stored into the first film roll sheet in the case of detecting that the creation of the first film roll sheet is completed.

In this embodiment of the present application, after the detection device acquires the data transmission signal, the production process information that is not transmitted can be fed back to the statistical process control system.

After the statistical process control system acquires the production process information, whether the creation of the first film roll sheet is completed can be detected. If it is detected that the creation is not completed, the production process information can be stored into the target cache space. The target cache space described here may be the same as the cache space described in the above embodiment, or may be a different cache space. If it is detected that the creation is completed, the production process information can be recorded in the first film roll sheet. At the same time, the production process information stored in the target cache space can also be recorded in the first film roll sheet, and the target cache space can be cleared.

In the above embodiment, in the case of detecting that the creation of the first film roll sheet is not completed, more comprehensive production process information can be obtained by caching the production process information in the target cache space, thereby improving the comprehensiveness and reliability of the production process information in the first film roll sheet.

In some embodiments of the present application, the sending a processing request for film roll numbers to the manufacturing execution system of the coating machine specifically includes the following steps:
a second film roll number is determined in the case of determining that the substrate to be coated contains a coated surface, wherein the second film roll number is the film roll number obtained during the coating process of the coated surface, and the substrate to be coated is the substrate that needs to be coated after being connected to the target film roll; and a processing request carrying the second film roll number is sent to the manufacturing execution system, wherein the processing request is used to request the generation of the first film roll number and establish an association relationship between the first film roll number and the second film roll number.

From the above description, it can be seen that coating machines include single-layer coating machines and double-layer coating machines. In a coating process, a single-layer coating machine performs a coating operation on one coating surface of the substrate to be coated. Here, the coating mode of the single-layer coating machine can be set through the statistical process control system. For example, the coating mode of the single-layer coating machine can be set as a mode 1 and a mode 2, wherein the mode 1 means coating the first surface of the substrate to be coated, and the mode 2 means coating the second surface after the first surface of the substrate to be coated is coated.

At this time, the statistical process control system of the single-layer coating machine can determine whether the substrate to be coated contains a coated surface based on the coating mode, wherein the substrate to be coated can be understood as the substrate placed on the unwinding apparatus of the coating machine for performing the coating process. If it is determined that the coated surface is contained, a second film roll number can be determined, which is the film roll number obtained during the coating process of the coated surface.

Here, in a case that the coating mode of the single-layer coating machine is set to be the mode 2, an electronic tag disposed on the substrate to be coated can be scanned by a tag scanning apparatus disposed in the coating machine, so as to obtain the second film roll number. After the coating machine detects that the winding apparatus is disconnected and connected to the target film roll, a roll change signal can be generated and written into the first storage address. At the same time, the second film roll number can also be written into the second storage address.

In a case that the statistical process control system determines that the substrate to be coated placed by the unwinding apparatus of the coating machine contains a coated surface, if it is determined that a roll change signal is detected based on the first storage data in the first storage address, it is possible to continue to read the second film roll number stored in the second storage address. Then, the statistical process control system can send a processing request carrying the second film roll number to the manufacturing execution system. After the manufacturing execution system acquires the processing request, the first film roll number can be generated, and the association relationship between the first film roll number and the second film roll number can be established.

Through the above processing mode, film roll sheets generated during the coating process on each coating surface of the substrate can be associated, thereby achieving the association of production process information, and ensuring quick and accurate traceability of film rolls during battery production.

Referring to FIG. 22, an embodiment of the present application provides a coating method. The method is applied to the manufacturing execution system of the coating machine, and specifically includes the following steps:

S801: A first film roll number of a target film roll is generated in response to a processing request for film roll numbers sent by the statistical process control system of the coating machine.

When the coating machine detects that the diameter of the film roll wound by the winding apparatus of the coating machine reaches a set value (such as 1.2 m), the coating machine generates a roll change signal. At this time, the winding apparatus of the coating machine is automatically disconnected and connected to a new film roll drum. After the statistical process control system detects the roll change signal of the coating machine, a processing request for film roll numbers can be sent to the manufacturing execution system of the coating machine.

In this embodiment of the present application, the statistical process control system may be a statistical process control (SPC) system, and the manufacturing execution system may be an MES. After the manufacturing execution system acquires the processing request, the first film roll number of the target film roll is determined in response to the processing request.

In this embodiment of the present application, the film roll number may include, but is not limited to, the following: position information, time information, coating surface information, and indicator, wherein the position information is used to indicate the position of the coating machine; the coating surface information is used to indicate the information of the coating surface of the coating machine; the time information is used to indicate the production date of the coating slurry and the coating date of the substrate; and the indicator is an indicator generated according to the sending order of the processing request. Here, the film roll number is a carrier of film roll related information, and material identification and tracing can be achieved through the film roll number.

S802: The first film roll number is sent to the statistical process control system, wherein the first film roll number is used to create a first film roll sheet of the target film roll, and the first film roll sheet is used to record the production process information of the target film roll during the coating process.

After the manufacturing execution system generates the first film roll number, the first film roll number can be sent to the statistical process control system.

Here, the first film roll sheet is used to record the production process information of the target film roll during the coating process. The production process information includes, but is not limited to, information such as production base of the target film roll, workshop, machine, date, formula, time, weight data and real-time dimension data of the substrate during the coating process, and process parameters of the coating machine. Here, the weight data includes the substrate weight before coating, the substrate weight after the first surface of the substrate is coated, and the substrate weight after the first and second surfaces of the substrate are coated. In this embodiment of the present application, the substrate weight can be determined by measuring the density data of the substrate. Here, the density data includes surface density of the substrate, surface density of the first surface, and surface density of the first surface and the second surface, wherein the surface density of the substrate is used to indicate the surface density of the uncoated substrate in the target film roll, the surface density of the first surface is used to indicate the surface density after one surface of the substrate is coated, and the surface density of the first surface and the second surface is used to indicate the surface density after two surfaces of the substrate are coated.

Here, the first surface and the second surface are two opposite coating surfaces of the substrate. Usually, the first surface is referred to as a surface A, and the second surface is referred to as a surface B.

In the technical solution of the embodiment of the present application, the first film roll number of the target film roll can be generated after detecting the processing request for film roll numbers sent by the statistical process control system of the coating machine, and the first film roll number is sent to the statistical process control system, wherein the first film roll number is used to create a first film roll sheet of the target film roll, and the first film roll sheet is used to record the production process information of the target film roll during the coating process. The above processing does not require the manual input of film roll numbers, and also does not require the creation of a film roll sheet based on manually inputted film roll numbers. By means of generating the first film roll number of the target film roll in response to the processing request for film roll numbers sent by the statistical process control system and automatically returning the first film roll number to the statistical process control system, the process of generating the first film roll number can be automatically completed, thereby improving the degree of automation of the entire process, saving the labor cost, improving the consistency of film roll identifiers set on the first film roll sheet and the film roll, and reducing errors caused by manual operation.

In some embodiments of the present application, on the basis of the above embodiment, the method further includes the following steps:
a first film roll number is generated in response to a processing request for film roll numbers sent by the statistical process control system of the coating machine, and a second film roll number is determined, wherein the second film roll number is the film roll number generated during the coating process of the coated surface of the substrate to be coated, and the substrate to be coated is the substrate for coating to obtain a target film roll; and an association relationship between the first film roll number and the second film roll number is established.

In this embodiment of the present application, the statistical process control system determines a second film roll number in the case of determining that the substrate to be coated contains a coated surface, and sends a processing request carrying the second film roll number to the manufacturing execution system. Here, the process in which the statistical process control system determines whether the substrate to be coated contains a coated surface is the same as the process described in the above embodiments, and will not be described in detail here.

After the manufacturing execution system acquires the processing request, each request field in the processing request can be parsed, so as to parse the number field to obtain the second film roll number and generate the first film roll number; and then, the association relationship between the first film roll number and the second film roll number can be established.

Here, an association relationship table can be preset, and film roll numbers with association relationships can be recorded through the association relationship table. At this time, the first film roll number and the second film roll number can be recorded in the association relationship table to establish the association relationship between the first film roll number and the second film roll number.

Through the above processing mode, film roll sheets generated during the coating process on each coating surface of the substrate can be associated, thereby achieving the association of production process information, and ensuring quick and accurate traceability of film rolls during battery production.

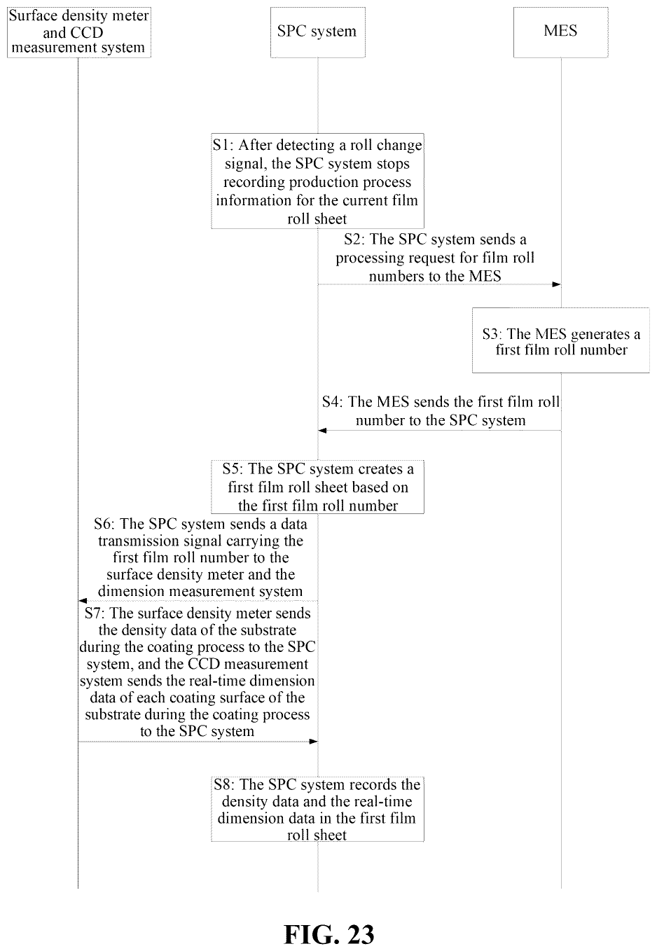

A process for processing film roll sheets in a coating process is illustrated with a specific example below. In the specific example, the statistical process control system is an SPC system, the manufacturing execution system is an MES, the controller of the coating machine is a PLC of the coating machine, and the detection device includes a surface density meter and a CCD measurement system. Referring to the schematic flowchart shown in FIG. 23, the specific example specifically includes the following steps.

S1: After detecting a roll change signal, the statistical process control system stops recording production process information for the current film roll sheet.

In the case of detecting that the diameter of the film roll wound by the winding apparatus of the coating machine reaches a set value (such as 1.2 m), the winding apparatus of the coating machine is automatically disconnected through the cutter apparatus and connected to a new film roll. After the controller (such as the PLC) of the coating machine detects the automatic disconnecting operation of the cutter apparatus, a roll change signal is generated, and the roll change signal is written into the first storage address. For example, a roll change signal “1” can be generated, and the roll change signal “1” is written into the first storage address.

The statistical process control system reads the data in the first storage address as the first storage data; and then, the statistical process control system can determine whether a roll change signal is detected based on the read first storage data. At this time, whether the first storage data is the first data can be determined. If it is determined that the first storage data is the first data, it can be determined that the roll change signal is detected.

After a roll change signal is detected, a transmission stop signal can be sent to the detection device to indicate the detection device to stop sending the detected production process information to the statistical process control system and stop recording the production process information for the current film roll sheet.

S2: The statistical process control system sends a processing request for film roll numbers to the manufacturing execution system.

After the statistical process control system detects the roll change signal of the coating machine, a processing request for film roll numbers can be sent to the manufacturing execution system of the coating machine.

S3: The manufacturing execution system generates a first film roll number.

Here, the first film roll number may include, but is not limited to, the following: base, workshop, cathode and anode, slurry date, and N-digit serial number, wherein the base and workshop are used to indicate the base and workshop where the coating machine is located; the cathode and anode are used to indicate whether the surface coated by the coating machine is a cathode surface or an anode surface; the slurry date is used to indicate the production date of the coating slurry and the date of the coating process on the substrate; and the N-digit serial number is a serial number generated according to the order in which the statistical process control system of each coating machine sends a processing request, wherein N may be a positive integer greater than 1.

S4: The manufacturing execution system sends the first film roll number to the statistical process control system.

Here, after the manufacturing execution system generates the first film roll number, the first film roll number can be sent to the statistical process control system.

S5: The statistical process control system creates a first film roll sheet based on the first film roll number.

After the statistical process control system acquires the first film roll number, a first film roll sheet can be created based on the first film roll number. Here, a film roll sheet template that matches the coating machine can be acquired from a film roll sheet template library; and the name of the film roll sheet template is determined based on the first film roll number to obtain the first film roll sheet. The name of the first film roll sheet is recorded as the first film roll number.

Here, the first film roll sheet is used to record the production process information of the target film roll during the coating process. The production process information includes, but is not limited to, information such as production base of the target film roll, workshop, machine, date, formula, time, weight data and real-time dimension data of the substrate during the coating process, and process parameters of the coating machine. Here, the weight data includes the substrate weight before coating, the substrate weight after the first surface of the substrate is coated, and the substrate weight after the first and second surfaces of the substrate are coated.

S6: The statistical process control system sends a data transmission signal carrying the first film roll number to the surface density meter and the CCD measurement system.

S7: The surface density meter sends the density data of the substrate during the coating process to the statistical process control system, and the CCD measurement system sends the real-time dimension data of each coating surface of the substrate during the coating process to the statistical process control system.

S8: The statistical process control system records the density data and the real-time dimension data in the first film roll sheet.

The process described above is completed automatically by the system without human intervention, so as to effectively alleviate the problem of incorrect input of film roll numbers due to human errors such as misremembering, pressing a wrong key, and accidentally touching a keyboard, thereby improving the accuracy of film roll numbers. Because the information transmission speed among the statistical process control system, the manufacturing execution system and the controller is relatively fast, usually at the ms level, the total duration from the roll change to the completion of creation of a film roll sheet and the start of data recording in the film roll sheet is less than 1 s. Compared with the prior art of manually inputting a film roll number and then manually creating a film roll sheet according to the film roll number, the creation time of the film roll sheet can be shortened, the time difference can be eliminated, and the consistency between roll stocks and film roll sheet data can be improved.

The above description of the embodiments tends to emphasize the differences between the embodiments, and the same or similar aspects thereof can be referenced to each other. For the sake of simplicity, the same or similar aspects will not be repeated here.

Another embodiment of the present application provides an electronic device. The electronic device includes a memory, a processor, and a computer program stored in the memory and capable of running on the processor. The processor executes the program to implement the method provided in any of the above embodiments.

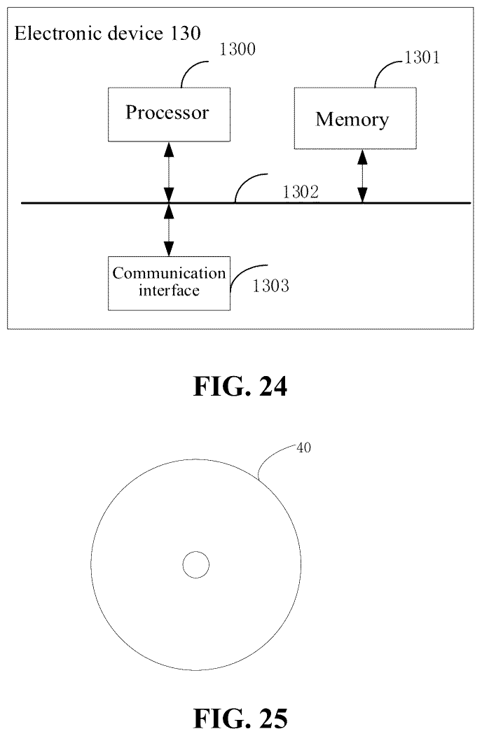

As shown in FIG. 24, an electronic device 130 may include: a processor 1300, a memory 1301, a bus 1302, and a communication interface 1303. The processor 1300, the communication interface 1303, and the memory 1301 are connected through the bus 1302. The memory 1301 stores a computer program capable of running on the processor 1300. The processor 1300, when running the computer program, executes the method provided in any of the above embodiments in the present application.

The memory 1301 may include a high-speed random access memory (RAM), and may also include a non-volatile memory, such as at least one disk memory. The communication connection between the system network element and at least one of the other network elements is achieved through at least one communication interface 1303 (which may be a wired or wireless interface), and the Internet, a wide area network, a local area network, a metropolitan area network, and the like may be used.

The bus 1302 may be an industry standard architecture (ISA) bus, a peripheral component interconnect (PCI) bus, an extended industry standard architecture (EISA) bus, or the like. The bus may be classified as an address bus, a data bus, a control bus, or the like. The memory 1301 is configured to store a program, and the processor 1300 executes the program after receiving an execution instruction. The method disclosed in any of the above embodiments of the present application may be applied to the processor 1300, or implemented by the processor 1300.

The processor 1300 may be an integrated circuit chip and has a signal processing capability. In an implementation process, each step of the above method may be completed by an integrated logic circuit of hardware in the processor 1300 or an instruction in a software form. The above processor 1300 may be a general-purpose processor, including a central processing unit (CPU), a network processor (NP), or the like, and may also be a digital signal processor (DSP), an application specific integrated circuit (ASIC), a field-programmable gate array (FPGA), or other programmable logic devices, discrete gate or transistor logic devices, or discrete hardware components. Various methods, steps and logical block diagrams disclosed in the embodiments of the present application may be implemented or executed. The general-purpose processor may be a microprocessor or may be any conventional processor. The steps of the method disclosed with reference to the embodiments of the present application may be directly executed by a hardware decoding processor, or may be executed by a combination of hardware and software modules in a decoding processor. The software module may be located in a mature storage medium in this field, such as a random access memory, a flash memory, a read only memory, a programmable read only memory, an electrically erasable programmable memory, or a register. The storage medium is located in the memory 1301, and the processor 1300 reads the information in the memory 1301 and completes the steps of the above method in combination with its hardware.

The electronic device provided in the embodiments of the present application and the method provided in the embodiments of the present application have the same inventive concept, and have the same beneficial effects as the methods used, operated, or implemented.

Another embodiment of the present application provides a computer-readable storage medium storing a computer program, and the program is executed by a processor to implement the method according to any of the above embodiments.

Referring to FIG. 25, the computer-readable storage medium illustrated therein is an optical disk 40 storing a computer program (i.e., a program product), and the computer program, when run by a processor, executes the method provided by any of the above embodiments.

It should be noted that examples of the computer-readable storage medium may also include, but not limited to, a phase-change random access memory (PRAM), a static random access memory (SRAM), a dynamic random access memory (DRAM), other types of random access memory (RAM), a read-only memory (ROM), an electrically erasable programmable read-only memory (EEPROM), a flash memory, or other optical and magnetic storage media, which will not be repeated herein.

Another embodiment of the present application provides a computer program product including a computer program, and the program is executed by a processor to implement the control method according to any of the above embodiments.

The computer-readable storage medium and computer program product provided in the above embodiment of the present application and the method provided in the embodiments of the present application have the same inventive concept, and have the same beneficial effects as the method used, operated, or implemented by the stored application program.

It should be noted that:
the term “module” is not intended to be limited to a particular physical form. Depending on the specific application, modules may be implemented as hardware, firmware, software, and/or combinations thereof. In addition, different modules may share common components or even be implemented by the same components. Clear boundaries between different modules may or may not exist.

The algorithms and displays provided herein are not inherently associated with any particular computer, virtual apparatus, or other device. Various universal apparatuses may also be used together with the examples based herein. The structure required for constructing such apparatuses is obvious according to the above description. Furthermore, the present application is not directed to any particular programming language. It should be understood that a variety of programming languages may be utilized to implement the content of the present application as described herein, and the above description for particular languages is intended to disclose the best embodiment of the present application.

It should be understood that although the steps in the flowcharts of the accompanying drawings are shown sequentially as indicated by the arrows, these steps are not necessarily performed sequentially in the order indicated by the arrows. Unless explicitly stated herein, these steps are performed in no strict order, and may be performed in any other order. Moreover, at least part of the steps in the flowcharts of the accompanying drawings may include a plurality of sub-steps or a plurality of stages. These sub-steps or stages are not necessarily performed at the same time, but may be performed at different times. These sub-steps or stages are not necessarily performed in order, but may be performed in turn or alternately with other steps or at least part of the sub-steps or stages of other steps.

The above embodiments only express the embodiment of the present application, and the description thereof is relatively specific and detailed, but it cannot be understood as a limitation on the scope of the patent of the present application. It should be noted that for those of ordinary skill in the art, a number of variations and improvements can be made without departing from the conception of the present application, which fall within the scope of protection of the present application. Therefore, the scope of protection of the present application shall be subject to the attached claims.

What is claimed is:

1. A method for generating film roll sheets, comprising:
acquiring a parameter processing mode of film roll parameters, wherein the parameter processing mode is used to indicate a parameter acquisition manner of the film roll parameters in the current operating state of a coating machine;
acquiring the parameter content of the film roll parameters according to the parameter acquisition manner indicated by the parameter processing mode; and
generating a new film roll sheet based on the parameter content, wherein the new film roll sheet is used to record coating process parameters of a substrate.

2. The method according to claim 1, wherein the acquiring the parameter content of the film roll parameters according to the parameter acquisition manner indicated by the parameter processing mode comprises:
displaying a first page corresponding to the parameter processing mode based on a detected film roll sheet creation request, wherein the parameter acquisition manner indicated by the parameter processing mode comprises acquisition through the first page; and
acquiring the parameter content of the film roll parameters through the first page.

3. The method according to claim 2, wherein the acquiring the parameter content of the film roll parameters through the first page comprises:
displaying a parameter editing area of the film roll parameters through the first page; and
determining the parameter content of the film roll parameters in response to the edited content in the parameter editing area.

4. The method according to claim 3, wherein the generating a new film roll sheet based on the parameter content comprises:
performing validity check on the parameter content in the case of detecting a parameter check event to obtain a check result; and
generating the new film roll sheet based on the parameter content in the case of determining that the check result is successful.

5. The method according to claim 4, wherein the performing validity check on the parameter content in the case of detecting a parameter check event to obtain a check result comprises:
performing check on the content length of the parameter content to obtain a first sub-check result;
performing check on various components of the parameter content to obtain a second sub-check result; and
obtaining the check result based on the first sub-check result and the second sub-check result.

6. The method according to claim 4, wherein the method further comprises:
controlling a check display identifier in the first page to be switched from a first display state to a second display state in the case of determining that the check result is successful, wherein the second display state is used to indicate that the check result is successful.

7. The method according to claim 2, wherein the acquiring the parameter content of the film roll parameters through the first page comprises:
displaying a parameter display area of the film roll parameters and an acquisition identifier of the film roll parameters through the first page;
sending an acquisition request to a film roll management system in the case of detecting a trigger event for the acquisition identifier; and
acquiring the parameter content returned by the film roll management system based on the acquisition request, and displaying the parameter content in the parameter display area.

8. The method according to claim 7, wherein the generating a new film roll sheet based on the parameter content comprises:
detecting a roll change signal of the coating machine according to a preset time interval in the case of determining that a target detection identifier indicates that the detection is enabled, wherein the target detection identifier is used to indicate whether to perform detection of the roll change signal; and
generating the new film roll sheet based on the parameter content in the case of detecting the roll change signal.

9. The method according to claim 1, wherein the acquiring the parameter content of the film roll parameters according to the parameter acquisition manner indicated by the parameter processing mode comprises:
acquiring the parameter content of the film roll parameters from a target management system in the case of detecting the roll change signal of the coating machine.

10. The method according to claim 9, wherein the method further comprises:
determining and displaying a second page based on a detected parameter viewing request, and displaying the parameter display area of the film roll parameters in the second page.

11. The method according to claim 1, wherein the method further comprises:
stopping entering coating process parameters into the current film roll sheet in the case of detecting that the current film roll sheet is completed, storing the current film roll sheet into a target storage space, and performing an operation of generating a new film roll sheet based on the parameter content.

12. The method according to claim 1, wherein the method further comprises:
displaying a third page based on a detected input request of film roll sheet attributes, wherein the third page contains an attribute editing area; and
determining film roll sheet attributes of the new film roll sheet based on the edited content in the attribute editing area.

13. The method according to claim 12, wherein the method further comprises:
acquiring a target film roll sheet of the coated surface in the case of determining that a substrate to be coated contains a coated surface based on the film roll sheet attributes; and
establishing an association relationship between the target film roll sheet and the new film roll sheet.

14. An apparatus for generating film roll sheets, comprising:
a first acquisition unit, configured to acquire a parameter processing mode of film roll parameters, wherein the parameter processing mode is used to indicate a parameter acquisition manner of the film roll parameters in the current operating state of a coating machine;
a second acquisition unit, configured to acquire the parameter content of the film roll parameters according to the parameter acquisition manner indicated by the parameter processing mode; and
a generation unit, configured to generate a new film roll sheet based on the parameter content, wherein the new film roll sheet is used to record coating process parameters of a substrate.

15. A coating system, comprising an unwinding apparatus, a driving apparatus, a collection device, a winding apparatus, and a control apparatus, wherein
the driving apparatus is configured to drive a substrate unwound by the unwinding apparatus to move towards the winding apparatus, and the winding apparatus is configured to wind the substrate;
the collection device is configured to collect substrate parameters of the substrate passing through the collection device; and
the control apparatus is configured to predict the winding time when the substrate is wound by the winding apparatus based on coating process parameters, and store the substrate parameters acquired from the collection device into the film roll sheet corresponding to the substrate at the winding time, wherein the film roll sheet is generated by the method for generating film roll sheets according to claim 1.

16. The coating system according to claim 15, wherein the control apparatus comprises: a host computer and a slave computer, wherein
the slave computer is configured to acquire driving parameters of the driving apparatus and transmit the driving parameters to the host computer; and
the host computer is configured to acquire the substrate parameters from the collection device, predict the winding time when the substrate is wound by the winding apparatus based on the driving parameters and pre-configured distance parameters, and store the substrate parameters into the film roll sheet corresponding to the substrate at the winding time, wherein the distance parameters are used to indicate the transmission distance between the collection device and the winding apparatus.

17. The coating system according to claim 16, wherein the host computer is configured to:
predict the transmission duration required for the substrate to be transmitted from the collection device to the winding apparatus based on the driving parameters and the distance parameters; and
calculate the winding time based on the transmission duration and the collection time of the substrate parameters collected by the collection device.

18. The coating system according to claim 17, wherein the host computer is configured to:
calculate the target distance of the substrate being transmitted in each rotational speed collection cycle based on rotational speed collection cycles contained in the driving parameters and the rotational speed collected in each rotational speed collection cycle;
calculate the cumulative number of collections based on the target distance and the distance parameters; and
calculate the product of the cumulative number of collections and the rotational speed collection cycle to obtain the transmission duration.

19. The coating system according to claim 15, wherein the coating system further comprises:
a cutter apparatus, configured to cut off the substrate passing through the cutter apparatus when it is determined that a roll change condition is met currently; and
the control apparatus, further configured to control the winding apparatus to be switched to a new roll drum and create a film roll sheet corresponding to the new roll drum.

20. The coating system according to claim 15, wherein the coating system further comprises a coating device, and the coating device comprises a coating die head and a coating oven, wherein
the coating die head is configured to coat the substrate passing through the coating die head; and
the coating oven is configured to bake the substrate coated by the coating die head.
